(19) United States
(12) Patent Application Publication
(10) Pub. No.: US 2025/0211976 A1
(43) Pub. Date: Jun. 26, 2025

(54) DEVICES AND METHODS AGAINST ADVERSARIAL ATTACKS IN WIRELESS COMMUNICATION SYSTEMS

(71) Applicant: Intel Corporation, Santa Clara, CA (US)

(72) Inventors: Ravikumar BALAKRISHNAN, Beaverton, OR (US); Nageen HIMAYAT, Danville, CA (US); Hassnaa MOUSTAFA, San Jose, CA (US); Matthew HOEKSTRA, Forest Grove, OR (US)

(21) Appl. No.: 18/393,782

(22) Filed: Dec. 22, 2023

(51) Int. Cl. H04W 12/03; G06F 21/57; H04W 12/04

(52) U.S. Cl. CPC H04W 12/03; G06F 21/57; H04W 12/04

(57) ABSTRACT

An apparatus may include a trusted execution environment and a processor configured to execute a machine learning (ML)-based application within the trusted execution environment, the ML-based application is configured to provide an output based on input data comprising telemetry data and decrypt encrypted data received by the trusted execution environment to obtain the telemetry data of the network.

### TECHNICAL FIELD

The disclosure relates to protecting machine learning (ML) models in ML-based algorithms in wireless communication systems from adversarial attacks in order to detect anomalies and obtain unspoiled telemetry data of a wireless network.

### BACKGROUND

ML-based algorithms in wireless communication systems are increasingly being adopted and deployed within wireless communication environments. For example, the Open Radio Access Network (O-RAN) alliance proposed artificial intelligence (AI) enabled radio access network (RAN) interfaces for a variety of tasks including Traffic Steering, Massive Multiple-Input Multiple-Output (MIMO) Optimization, Handover Management, Quality of Experience (QoE) Optimization, Quality of Service (QOS) Based Resource Optimization, etc.

However, due to the black-box nature of ML-based algorithms in wireless communication systems, those systems may be susceptible to various vulnerabilities, which may be exploited by various type of attacks, including but not limited to, training time attacks, such as model poisoning; inference time attacks (i.e., adversarial attacks); model inversion attacks, and the like.

Among those threats, adversarial attacks may be highly relevant to wireless system implementations as they happen at the runtime of ML algorithms. ML algorithms running at inference time often rely on acceleration using custom implementations on dedicated hardware which expands the threat surface for potential adversarial attacks. It may be desirable to identify and address the emerging threat models and outline methods to protect ML models and accordingly ML-based algorithms in wireless communication systems from adversarial attacks.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 shows an exemplary radio communication network;

FIG. 2 shows an exemplary internal configuration of a communication device;

FIG. 3 shows an example of a resource grid;

FIG. 4 shows an example of a device according to various examples in this disclosure;

FIG. 5 shows an example of a processor and a memory of a device according to various aspects provided in this disclosure;

FIG. 6 illustrates an exemplary illustration of an information flow;

FIG. 7 illustrates an exemplary association between a device and a network access node;

FIG. 8 shows an exemplary illustration of a network;

FIG. 9 shows schematically an example of a chart displaying the performance of ML-based and non-ML-based algorithms;

FIG. 10 shows an exemplary radio access network architecture;

FIG. 11 shows an example of a method;

FIG. 12 shows an example of a method.

### DESCRIPTION

Various aspects described herein relate to an apparatus and methods for successfully defending against adversarial attacks in a radio communication network.

The following detailed description refers to the accompanying drawings that show, by way of illustration, exemplary details, and aspects in which aspects of the present disclosure may be practiced.

Adversarial machine learning may be one of the subjects that is actively investigated and studied in the computer vision field in which adversaries/attackers may conduct various attacks to disrupt a ML model that may be in use for generating output data based on the input. In a physical domain, examples of an adversarial attack may include noise addition to RGB images either in the digital domain or physically by integrating a patch and/or sticker onto test time images. For instance, spoiling a stop sign on a road with a sticker, or exposing the sensor of a camera to a laser beam to make the camera generate spoiled images due to the damaged sensor, etc. Such attacks may inject a particular amount of noise depending on the distortion imposed on the original data and may cause an ML model to perform unexpectedly and to generate output that is likely to lead wrong or suboptimal actions within a given context.

Defending against those attacks may typically include generating noised images and using them as a part of training data for the ML models with the aim of creating ML models that display robustness in the presence of such inputs perturbated by noise. However, the improved robustness that emerged from adversarial training-based approaches may not come without a tradeoff. A typical outcome in exchange for the improved robustness may be reduced performance of the ML model in terms of accuracy. Reduction of accuracy of the ML model may lead to misclassifying of a certain data point or a prediction of a data point beyond a predefined error margin.

Moreover, adversarial samples such as the noisy data may be unique for a particular attack algorithm and may not be as effective when encountered with other attacks using a different algorithm. Another downside may lie in the consideration that the synthetically generated noise injected into the data may not represent the noise generated on the field, especially from wireless jammers, and the like. Therefore, this technique may not provide an effective defense against such attacks. That is, a noise produced in a controlled environment may not resemble a noise produced in a real-world scenario in which no to limited control may be provided by a supervising entity.

In accordance with the various aspects provided herein, issues regarding different threat models that may allow an adversary to modify, or affect in anyway the information represented by, telemetry data used by ML-based algorithms in wireless communication systems are addressed. The telemetry data may refer to real-time and/or historical data about performance metrics of the network, user behavior, and various network parameters. Illustratively, telemetry data may include channel measurements performed by terminal devices (e.g. user device) or network access nodes. Such channel measurements may include, for example, reference signal received power (RSRP) measurements, channel state information (CSI), and the like.

There are various threat models, some of which may cause disruption of the ML models used in ML-based algorithms. For example, a threat model may be considered as to introduce noise in the telemetry data thereby causing the ML model to produce inferior results compared to the results that the model would produce with an input not including noise from an adversarial attack. Therefore, solutions that provide effective defense against different threat models may be needed. A defined set of categories may be used to classify the threat models. The scope of the defined categories may point out that the defined categories are broad in the sense that a plurality of adversarial techniques may fall into one of those categories. Accordingly, some threat models defined herein may pertain to one of: compromised and/or malicious trusted node and/or network interface, which may be referred to as threat model A, compromised and/or malicious network access nodes (e.g. base stations) and terminal devices (e.g. user devices), which may be referred to as threat model B, and over-the-air attacks using signal jammers, which may be referred to as threat model C.

Successful defense against adversarial attacks may require a combination of software, hardware, and algorithmic security solutions. In particular, for threat models A and B, a hardware-based attestation, e.g. in a trusted platform module (TPM), may be provided as a security solution. In some aspects, the hardware-based attestation may ensure the correctness (e.g. authenticity) of hardware and software configurations of the devices that communicate (e.g. transmit and/or receive) the telemetry data and/or perform computation with the telemetry data. In that way, a trusted node in which the ML-based application is executed may process the telemetry data in a secure and integrity-protected manner, specifically when the trusted node shares hardware or uses a shared memory with other potentially malicious and/or compromised applications. Illustratively, such a node herein may refer to a secure network element in the O-RAN system.

For threat model C, a plurality of algorithmic implementation methods including statistical methods or algorithms aiming to detect anomalies in the telemetry data may be provided to successfully detect the presence of adversarial attacks (e.g. jammer attacks) as well as to put forward defensive measures against those attacks.

ML techniques developed for deployment in wireless communication systems may typically be dependent on features and characterizations that describe a network environment, such as queue information, and the like. Such features may relate to information that may span several network access nodes across the radio communication network. As described above, telemetry data may include any type of data that may represent conditions of the network, characteristics associated to cells and/or user equipments (UEs), various performance metrics, etc. Illustratively, the telemetry data may include Reference Signal Received Power (RSRP) measurements, RSRP reports, Channel State Information (CSI), etc.

The telemetry data may be propagated over communication interfaces and handled by network access nodes or further nodes of the network. Through the travel of the telemetry data from its source to an entity that implements an ML model that uses the telemetry data, which the journey may include transmission/reception of one or more intermediary nodes within the network, the telemetry data may be subject to manipulation via data preprocessing techniques, such as quantization. The data preprocessing stage may result in a manipulated telemetry data for an ML model to accept it as input. The information that forms input for the corresponding ML model may not be passed to ML model before preprocessing. Thus, the resulting input may be a preprocessed information (e.g., telemetry data).

In accordance with the various aspects disclosed herein, an adversary may aim to add a small amount of noise. The phrase “small amount of noise” may refer to a data injection performed by the adversary in which the injected data may cause a subtle level of jitter in the original information and thus may not be detected in a straight-forward manner. Therefore, although the added noise may initially disrupt the original information, the detection of the noise may be challenging.

However, the noise may potentially harm the output of the model dramatically. The output may point to a result or set of results falling beyond a predefined error range and/or beyond an expected or optimal outcome. In that sense, the output may be significantly different from what is expected from the ML model to generate such as the optimum output the ML model has been tuned to generate, or an expected output not diverging beyond a predefined range, etc.

The difference in the output may result in, for example in a case of handover management, a trigger actuated earlier than it is supposed to be actuated, a trigger actuated later than it is supposed to be actuated or performing handover to a network access node (e.g. base station) that is suboptimal, all in light of and compared to the original information that theoretically does not include an “external noise” caused by an adversarial attack. Thus, it may be evident that effective defense and applicable solutions against the threat models are necessary in order not to suffer from the inferior results that may cause degradation in QoE, QOS, traffic steering, etc.

In some aspects, the solutions may refer to or encompass the utilization of a hardware and/or software in which the hardware and software may be functionally associated entities. The solutions may further refer to algorithmic implementations, methods, hardware-based security, software-based security, a security system in which both hardware and software resources are used, a combinational system leveraging hardware-based security, system implementation security, and the adversarial training-based defense, and the like. The solutions described within the scope of the disclosure may be, in non-limiting manner, associated with detecting presence of an adversarial attack, detecting an anomaly within data, detecting a noise injection by the adversarial attack, defending against an adversarial attack, mitigating the effect caused by an adversarial attack,

It is to be noted that the terms “AI model” and “ML model” are often used interchangeably in the literature, but there may also be some subtle differences between the two. An AI (Artificial Intelligence) model refers to a computational system that aims to perform tasks that would typically require human intelligence, such as problem-solving, pattern recognition, classification, and perception. AI models can be developed using various techniques, which may or may not include machine learning. AI models may include rule-based and rely on pre-defined logic, while they may also include the use of machine learning algorithms to adapt and improve over time. A machine learning model is considered a particular type of AI model that may learn from data. Machine learning models can be supervised (learning from labeled data), unsupervised (learning from unlabeled data), or reinforcement learning (learning from interactions with an environment). AI models that do not use machine learning techniques may typically include rule-based systems or systems that rely on pre-defined logic and knowledge representation. These models are designed and built by human experts who encode the rules and knowledge directly into the system. In this sense, they are not “trained” like machine learning models, which learn from data. However, rule-based AI models may also be updated and improved by refining the rules or adding new ones, which may require human intervention or may be provided via a particular training module that may change parameters associated with the defined rules. These updates can be considered a form of “training”. The term used in this disclosure, namely AI/ML, encompasses in particular machine learning models, but it may also include Als that do not involve a machine learning model particularly, but which may be trained. The term “model” used herein may be understood as any kind of algorithm, which provides output data based on input data provided to the model (e.g., any kind of algorithm generating or calculating output data based on input data).

The apparatuses and methods of this disclosure may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the following examples. Various exemplary radio communication technologies that the apparatuses and methods described herein may utilize include, but are not limited to: a Global System for Mobile Communications (“GSM”) radio communication technology, a General Packet Radio Service (“GPRS”) radio communication technology, an Enhanced Data Rates for GSM Evolution (“EDGE”) radio communication technology, and/or a Third Generation Partnership Project (“3GPP”) radio communication technology, for example Universal Mobile Telecommunications System (“UMTS”), Freedom of Multimedia Access (“FOMA”), 3GPP Long Term Evolution (“LTE”), 3GPP Long Term Evolution Advanced (“LTE Advanced”), Code division multiple access 2000 (“CDMA2000”), Cellular Digital Packet Data (“CDPD”), Mobitex, Third Generation (3G), Circuit Switched Data (“CSD”), High-Speed Circuit-Switched Data (“HSCSD”), Universal Mobile Telecommunications System (“Third Generation”) (“UMTS (3G)”), Wideband Code Division Multiple Access (Universal Mobile Telecommunications System) (“W-CDMA (UMTS)”), High Speed Packet Access (“HSPA”), High-Speed Downlink Packet Access (“HSDPA”), High-Speed Uplink Packet Access (“HSUPA”), High Speed Packet Access Plus (“HSPA+”), Universal Mobile Telecommunications System-Time-Division Duplex (“UMTS-TDD”), Time Division-Code Division Multiple Access (“TD-CDMA”), Time Division-Synchronous Code Division Multiple Access (“TD-CDMA”), 3rd Generation Partnership Project Release 8 (Pre-4th Generation) (“3GPP Rel. 8 (Pre-4G)”), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP 5G, 3GPP LTE Extra, LTE-Advanced Pro, LTE Licensed-Assisted Access (“LAA”), MuLTEfire, UMTS Terrestrial Radio Access (“UTRA”), Evolved UMTS Terrestrial Radio Access (“E-UTRA”), Long Term Evolution Advanced (4th Generation) (“LTE Advanced (4G)”), cdmaOne (“2G”), Code division multiple access 2000 (Third generation) (“CDMA2000 (3G)”), Evolution-Data Optimized or Evolution-Data Only (“EV-DO”), Advanced Mobile Phone System (1st Generation) (“AMPS (1G)”), Total Access Communication arrangement/Extended Total Access Communication arrangement (“TACS/ETACS”), Digital AMPS (2nd Generation) (“D-AMPS (2G)”), Push-to-talk (“PTT”), Mobile Telephone System (“MTS”), Improved Mobile Telephone System (“IMTS”), Advanced Mobile Telephone System (“AMTS”), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (“Autotel/PALM”), ARP (Finnish for Autoradiopuhelin, “car radio phone”), NMT (Nordic Mobile Telephony), High capacity version of NTT (Nippon Telegraph and Telephone) (“Hicap”), Cellular Digital Packet Data (“CDPD”), Mobitex, DataTAC, Integrated Digital Enhanced Network (“iDEN”), Personal Digital Cellular (“PDC”), Circuit Switched Data (“CSD”), Personal Handy-phone System (“PHS”), Wideband Integrated Digital Enhanced Network (“WiDEN”), iBurst, Unlicensed Mobile Access (“UMA”), also referred to as also referred to as 3GPP Generic Access Network, or GAN standard), Zigbee, Bluetooth®, Wireless Gigabit Alliance (“WiGig”) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p and other) Vehicle-to-Vehicle (“V2V”) and Vehicle-to-X (“V2X”) and Vehicle-to-Infrastructure (“V2I”) and Infrastructure-to-Vehicle (“I2V”) communication technologies, 3GPP cellular V2X, DSRC (Dedicated Short Range Communications) communication arrangements such as Intelligent-Transport-Systems, and other existing, developing, or future radio communication technologies.

The apparatuses and methods described herein may use such radio communication technologies according to various spectrum management schemes, including, but not limited to, dedicated licensed spectrum, unlicensed spectrum, (licensed) shared spectrum (such as LSA=Licensed Shared Access in 2.3-2.4 GHZ, 3.4-3.6 GHZ, 3.6-3.8 GHz and further frequencies and SAS=Spectrum Access System in 3.55-3.7 GHZ and further frequencies), and may use various spectrum bands including, but not limited to, IMT (International Mobile Telecommunications) spectrum (including 450-470 MHz, 790-960 MHz, 1710-2025 MHZ, 2110-2200 MHZ, 2300-2400 MHZ, 2500-2690 MHz, 698-790 MHZ, 610-790 MHZ, 3400-3600 MHZ, etc., where some bands may be limited to specific region(s) and/or countries), IMT-advanced spectrum, IMT-2020 spectrum (expected to include 3600-3800 MHZ, 3.5 GHz bands, 700 MHz bands, bands within the 24.25-86 GHz range, etc.), spectrum made available under FCC's “Spectrum Frontier” 5G initiative (including 27.5-28.35 GHZ, 29.1-29.25 GHz, 31-31.3 GHZ, 37-38.6 GHz, 38.6-40 GHz, 42-42.5 GHZ, 57-64 GHz, 64-71 GHz, 71-76 GHZ, 81-86 GHz and 92-94 GHz, etc.), the ITS (Intelligent Transport Systems) band of 5.9 GHZ (typically 5.85-5.925 GHZ) and 63-64 GHZ, bands currently allocated to WiGig such as WiGig Band 1 (57.24-59.40 GHZ), WiGig Band 2 (59.40-61.56 GHZ) and WiGig Band 3 (61.56-63.72 GHZ) and WiGig Band 4 (63.72-65.88 GHZ), the 70.2 GHZ-71 GHz band, any band between 65.88 GHz and 71 GHZ, bands currently allocated to automotive radar applications such as 76-81 GHZ, and future bands including 94-300 GHz and above. Furthermore, the apparatuses and methods described herein can also employ radio communication technologies on a secondary basis on bands such as the TV White Space bands (typically below 790 MHZ) where e.g. the 400 MHz and 700 MHz bands are prospective candidates. Besides cellular applications, specific applications for vertical markets may be addressed such as PMSE (Program Making and Special Events), medical, health, surgery, automotive, low-latency, drones, etc. applications. Furthermore, the apparatuses and methods described herein may also use radio communication technologies with a hierarchical application, such as by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc. The apparatuses and methods described herein can also use radio communication technologies with different Single Carrier or OFDM flavors (CP-OFDM, SC-FDMA, SC-OFDM, filter bank-based multicarrier (FBMC), OFDMA, etc.) and e.g. 3GPP NR (New Radio), which can include allocating the OFDM carrier data bit vectors to the corresponding symbol resources.

For purposes of this disclosure, radio communication technologies may be classified as one of a Short-Range radio communication technology or Cellular Wide Area radio communication technology. Short Range radio communication technologies may include Bluetooth, WLAN (e.g., according to any IEEE 802.11 standard), and other similar radio communication technologies. Cellular Wide Area radio communication technologies may include Global System for Mobile Communications (“GSM”), Code Division Multiple Access 2000 (“CDMA2000”), Universal Mobile Telecommunications System (“UMTS”), Long Term Evolution (“LTE”), General Packet Radio Service (“GPRS”), Evolution-Data Optimized (“EV-DO”), Enhanced Data Rates for GSM Evolution (“EDGE”), High Speed Packet Access (HSPA; including High Speed Downlink Packet Access (“HSDPA”), High Speed Uplink Packet Access (“HSUPA”), HSDPA Plus (“HSDPA+”), and HSUPA Plus (“HSUPA+”)), Worldwide Interoperability for Microwave Access (“WiMax”) (e.g., according to an IEEE 802.16 radio communication standard, e.g., WiMax fixed or WiMax mobile), etc., and other similar radio communication technologies. Cellular Wide Arca radio communication technologies also include “small cells” of such technologies, such as microcells, femtocells, and picocells. Cellular Wide Arca radio communication technologies may be generally referred to herein as “cellular” communication technologies.

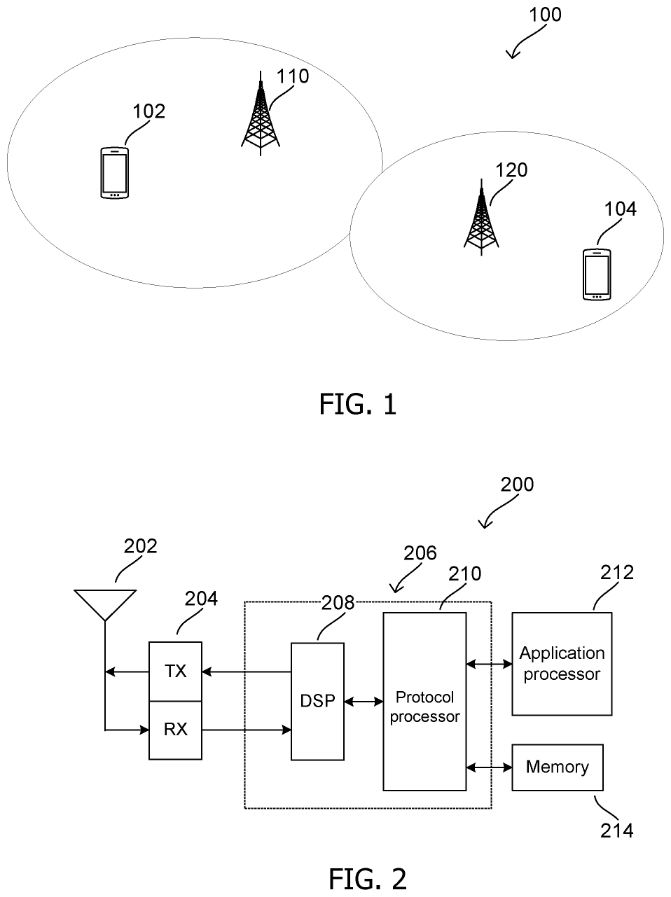

FIGS. 1 and 2 depict a general network and device architecture for wireless communications, including in particular aspects of a mobile communication network. In particular, FIG. 1 shows exemplary radio communication network 100 according to some aspects, which may include terminal devices 102 and 104 and network access nodes 110 and 120. Radio communication network 100 may communicate with terminal devices 102 and 104 via network access nodes 110 and 120 over a radio access network. Although certain examples described herein may refer to a particular radio access network context (e.g., LTE, UMTS, GSM, other 3rd Generation Partnership Project (3GPP) networks, WLAN/WiFi, Bluetooth, 5G NR, mmWave, etc.), these examples are demonstrative and may therefore be readily applied to any other type or configuration of radio access network. The number of network access nodes and terminal devices in radio communication network 100 is exemplary and is scalable to any amount.

In an exemplary cellular context, network access nodes 110 and 120 may be base stations (e.g., eNodeBs, NodeBs, Base Transceiver Stations (BTSs), gNodeBs, or any other type of base station), while terminal devices 102 and 104 may be cellular terminal devices (e.g., Mobile Stations (MSs), User Equipments (UEs), or any type of cellular terminal device). Network access nodes 110 and 120 may therefore interface (e.g., via backhaul interfaces) with a cellular core network such as an Evolved Packet Core (EPC, for LTE), Core Network (CN, for UMTS), or other cellular core networks, which may also be considered part of radio communication network 100. The cellular core network may interface with one or more external data networks. In an exemplary short-range context, network access node 110 and 120 may be access points (APs, e.g., WLAN or WiFi APs), while terminal device 102 and 104 may be short range terminal devices (e.g., stations (STAs)). Network access nodes 110 and 120 may interface (e.g., via an internal or external router) with one or more external data networks. Network access nodes 110 and 120 and terminal devices 102 and 104 may include one or multiple transmission/reception points (TRPs).

Network access nodes 110 and 120 (and, optionally, other network access nodes of radio communication network 100 not explicitly shown in FIG. 1) may accordingly provide a radio access network to terminal devices 102 and 104 (and, optionally, other terminal devices of radio communication network 100 not explicitly shown in FIG. 1). In an exemplary cellular context, the radio access network provided by network access nodes 110 and 120 may enable terminal devices 102 and 104 to wirelessly access the core network via radio communications. The core network may provide switching, routing, and transmission, for traffic data related to terminal devices 102 and 104, and may further provide access to various internal data networks (e.g., control nodes, routing nodes that transfer information between other terminal devices on radio communication network 100, etc.) and external data networks (e.g., data networks providing voice, text, multimedia (audio, video, image), and other Internet and application data). In an exemplary short-range context, the radio access network provided by network access nodes 110 and 120 may provide access to internal data networks (e.g., for transferring data between terminal devices connected to radio communication network 100) and external data networks (e.g., data networks providing voice, text, multimedia (audio, video, image), and other Internet and application data).

The radio access network and core network (if applicable, such as for a cellular context) of radio communication network 100 may be governed by communication protocols that can vary depending on the specifics of radio communication network 100. Such communication protocols may define the scheduling, formatting, and routing of both user and control data traffic through radio communication network 100, which includes the transmission and reception of such data through both the radio access and core network domains of radio communication network 100. Accordingly, terminal devices 102 and 104 and network access nodes 110 and 120 may follow the defined communication protocols to transmit and receive data over the radio access network domain of radio communication network 100, while the core network may follow the defined communication protocols to route data within and outside of the core network. Exemplary communication protocols include LTE, UMTS, GSM, WiMAX, Bluetooth, WiFi, mm Wave, etc., any of which may be applicable to radio communication network 100.

FIG. 2 shows an exemplary internal configuration of a communication device according to various aspects provided in this disclosure. The communication device may include a terminal device 102, and it will be referred to as communication device 200, but the communication device may also include various aspects of network access nodes 110, 120 as well. In some examples, the communication device 200 may be a further entity within the radio communication network 100, which may communicate with multiple network access nodes 110, 120. The communication device 200 may include antenna system 202, radio frequency (RF) transceiver 204, baseband modem 206 (including digital signal processor 208 and protocol controller 210), application processor 212, and memory 214. Although not explicitly shown in FIG. 2, in some aspects communication device 200 may include one or more additional hardware and/or software components, such as processors/microprocessors, controllers/microcontrollers, other specialty or generic hardware/processors/circuits, peripheral device(s), memory, power supply, external device interface(s), subscriber identity module(s) (SIMs), user input/output devices (display(s), keypad(s), touchscreen(s), speaker(s), external button(s), camera(s), microphone(s), etc.), or other related components.

Communication device 200 may transmit and receive radio signals on one or more radio access networks. Baseband modem 206 may direct such communication functionality of communication device 200 according to the communication protocols associated with each radio access network, and may execute control over antenna system 202 and RF transceiver 204 to transmit and receive radio signals according to the formatting and scheduling parameters defined by each communication protocol. Although various practical designs may include separate communication components for each supported radio communication technology (e.g., a separate antenna, RF transceiver, digital signal processor, and controller), for purposes of conciseness, the configuration of communication device 200 shown in FIG. 2 depicts only a single instance of such components.

Communication device 200 may transmit and receive wireless signals with antenna system 202. Antenna system 202 may be a single antenna or may include one or more antenna arrays that each include multiple antenna elements. For example, antenna system 202 may include an antenna array at the top of communication device 200 and a second antenna array at the bottom of communication device 200. In some aspects, antenna system 202 may additionally include analog antenna combination and/or beamforming circuitry. In the receive (RX) path, RF transceiver 204 may receive analog radio frequency signals from antenna system 202 and perform analog and digital RF front-end processing on the analog radio frequency signals to produce digital baseband samples (e.g., In-Phase/Quadrature (IQ) samples) to provide to baseband modem 206. RF transceiver 204 may include analog and digital reception components including amplifiers (e.g., Low Noise Amplifiers (LNAs)), filters, RF demodulators (e.g., RF IQ demodulators)), and analog-to-digital converters (ADCs), which RF transceiver 204 may utilize to convert the received radio frequency signals to digital baseband samples. In the transmit (TX) path, RF transceiver 204 may receive digital baseband samples from baseband modem 206 and perform analog and digital RF front-end processing on the digital baseband samples to produce analog radio frequency signals to provide to antenna system 202 for wireless transmission. RF transceiver 204 may thus include analog and digital transmission components including amplifiers (e.g., Power Amplifiers (PAS), filters, RF modulators (e.g., RF IQ modulators), and digital-to-analog converters (DACs), which RF transceiver 204 may utilize to mix the digital baseband samples received from baseband modem 206 and produce the analog radio frequency signals for wireless transmission by antenna system 202. In some aspects baseband modem 206 may control the radio transmission and reception of RF transceiver 204, including specifying the transmit and receive radio frequencies for operation of RF transceiver 204.

In some examples, communication device 200 may include a communication circuit. Communication device 200 may transmit and receive communication signals with the communication circuit. The communication circuit may be couplable to specified communication interfaces (e.g. E2, A1, O1, etc.). In some aspects, such communication interfaces may be implemented by wireless or wired connections (e.g. backhaul, etc.). In particular, the communication circuit may transmit and receive communication signals to/from network access nodes 110, 120, or an intermediate entity within the radio communication network 100 that may communicate with network access nodes 110, 120. The communication circuit may include RF transceiver 204, and in such an example, the RF transceiver 204 may be configured to transmit and receive communication signals via the respective communication interface.

As shown in FIG. 2, baseband modem 206 may include digital signal processor 208, which may perform physical layer (PHY, Layer 1) transmission and reception processing to, in the transmit path, prepare outgoing transmit data provided by protocol controller 210 for transmission via RF transceiver 204, and, in the receive path, prepare incoming received data provided by RF transceiver 204 for processing by protocol controller 210. Digital signal processor 208 may be configured to perform one or more of error detection, forward error correction encoding/decoding, channel coding and interleaving, channel modulation/demodulation, physical channel mapping, radio measurement and search, frequency and time synchronization, antenna diversity processing, power control and weighting, rate matching/de-matching, retransmission processing, interference cancelation, and any other physical layer processing functions. Digital signal processor 208 may be structurally realized as hardware components (e.g., as one or more digitally-configured hardware circuits or FPGAs), software-defined components (e.g., one or more processors configured to execute program code defining arithmetic, control, and I/O instructions (e.g., software and/or firmware) stored in a non-transitory computer-readable storage medium), or as a combination of hardware and software components. In some aspects, digital signal processor 208 may include one or more processors configured to retrieve and execute program code that defines control and processing logic for physical layer processing operations. In some aspects, digital signal processor 208 may execute processing functions with software via the execution of executable instructions. In some aspects, digital signal processor 208 may include one or more dedicated hardware circuits (e.g., ASICs, FPGAs, and other hardware) that are digitally configured to specific execute processing functions, where the one or more processors of digital signal processor 208 may offload certain processing tasks to these dedicated hardware circuits, which are known as hardware accelerators.

Exemplary hardware accelerators can include Fast Fourier Transform (FFT) circuits and encoder/decoder circuits. In some aspects, the processor and hardware accelerator components of digital signal processor 208 may be realized as a coupled integrated circuit. In accordance with various aspects provided herein, the digital signal processor 208 may implement the AI/ML and also AI/ML-based RRM algorithm operations some of which are described herein, and exemplarily via one or more dedicated hardware circuits (e.g., ASICs, FPGAs, and other hardware). In particular, the communication device 200 may include a plurality of such digital signal processors (e.g. digital signal processor 208) that are configured to implement multiple RRM algorithms. In an O-RAN environment, digital signal processors may perform processing, in particular for xApps or implement xApps.

Communication device 200 may be configured to operate according to one or more radio communication technologies. Digital signal processor 208 may be responsible for lower-layer processing functions (e.g., Layer 1/PHY) of the radio communication technologies, while protocol controller 210 may be responsible for upper-layer protocol stack functions (e.g., Data Link Layer/Layer 2 and/or Network Layer/Layer 3). Protocol controller 210 may thus be responsible for controlling the radio communication components of communication device 200 (antenna system 202, RF transceiver 204, and digital signal processor 208) in accordance with the communication protocols of each supported radio communication technology, and accordingly may represent the Access Stratum and Non-Access Stratum (NAS) (also encompassing Layer 2 and Layer 3) of each supported radio communication technology. Protocol controller 210 may be structurally embodied as a protocol processor configured to execute protocol stack software (retrieved from a controller memory) and subsequently control the radio communication components of communication device 200 to transmit and receive communication signals in accordance with the corresponding protocol stack control logic defined in the protocol software. Protocol controller 210 may include one or more processors configured to retrieve and execute program code that defines the upper-layer protocol stack logic for one or more radio communication technologies, which can include Data Link Layer/Layer 2 and Network Layer/Layer 3 functions. Protocol controller 210 may be configured to perform both user-plane and control-plane functions to facilitate the transfer of application layer data to and from radio communication device 200 according to the specific protocols of the supported radio communication technology. User-plane functions can include header compression and encapsulation, security, error checking and correction, channel multiplexing, scheduling and priority, while control-plane functions may include setup and maintenance of radio bearers. The program code retrieved and executed by protocol controller 210 may include executable instructions that define the logic of such functions.

Communication device 200 may also include application processor 212 and memory 214. Application processor 212 may be a CPU, and may be configured to handle the layers above the protocol stack, including the transport and application layers. Application processor 212 may be configured to execute various applications and/or programs of communication device 200 at an application layer of communication device 200, such as an operating system (OS), a user interface (UI) for supporting user interaction with communication device 200, and/or various user applications. The application processor may interface with baseband modem 206 and act as a source (in the transmit path) and a sink (in the receive path) for user data, such as voice data, audio/video/image data, messaging data, application data, basic Internet/web access data, etc. In the transmit path, protocol controller 210 may therefore receive and process outgoing data provided by application processor 212 according to the layer-specific functions of the protocol stack, and provide the resulting data to digital signal processor 208. Digital signal processor 208 may then perform physical layer processing on the received data to produce digital baseband samples, which digital signal processor may provide to RF transceiver 204. RF transceiver 204 may then process the digital baseband samples to convert the digital baseband samples to analog RF signals, which RF transceiver 204 may wirelessly transmit via antenna system 202. In the receive path, RF transceiver 204 may receive analog RF signals from antenna system 202 and process the analog RF signals to obtain digital baseband samples. RF transceiver 204 may provide the digital baseband samples to digital signal processor 208, which may perform physical layer processing on the digital baseband samples. Digital signal processor 208 may then provide the resulting data to protocol controller 210, which may process the resulting data according to the layer-specific functions of the protocol stack and provide the resulting incoming data to application processor 212. Application processor 212 may then handle the incoming data at the application layer, which can include execution of one or more application programs with the data and/or presentation of the data to a user via a user interface.

Memory 214 may embody a memory component of communication device 200, such as a hard drive or another such permanent memory device. Although not explicitly depicted in FIG. 2, the various other components of communication device 200 shown in FIG. 2 may additionally each include integrated permanent and non-permanent memory components, such as for storing software program code, buffering data, etc.

Application processor 212 may be configured to implement various operations provided herein, in particular with respect to the implementation of one or more AI/MLs that are used for RRM of multiple cells associated with multiple network access nodes (e.g. network access node 110, 120) serving to multiple terminal devices (e.g. terminal devices 102, 104). In some examples, application processor 212 may control an external processor that is configured to implement the one or more AI/MLs. In some aspects, the external processor may be particularly suitable for implementing AI/MLs, such as GPUs, neuromorphic chips or circuits, parallel processors, etc.

In accordance with some radio communication networks, terminal devices 102 and 104 may execute mobility procedures to connect to, disconnect from, and switch between available network access nodes of the radio access network of radio communication network 100. As each network access node of radio communication network 100 may have a specific coverage area, terminal devices 102 and 104 may be configured to select and re-select \ available network access nodes in order to maintain a strong radio access connection with the radio access network of radio communication network 100. For example, communication device 200 may establish a radio access connection with network access node 110 while terminal device 104 may establish a radio access connection with network access node 112. In the event that the current radio access connection degrades, terminal devices 102 or 104 may seek a new radio access connection with another network access node of radio communication network 100; for example, terminal device 104 may move from the coverage area of network access node 112 into the coverage area of network access node 110. As a result, the radio access connection with network access node 112 may degrade, which terminal device 104 may detect via radio measurements such as signal strength or signal quality measurements of network access node 112.

Depending on the mobility procedures defined in the appropriate network protocols for radio communication network 100, terminal device 104 may seek a new radio access connection (which may be, for example, triggered at terminal device 104 or by the radio access network), such as by performing radio measurements on neighboring network access nodes to determine whether any neighboring network access nodes can provide a suitable radio access connection. As terminal device 104 may have moved into the coverage area of network access node 110, terminal device 104 may identify network access node 110 (which may be selected by terminal device 104 or selected by the radio access network) and transfer to a new radio access connection with network access node 110. Such mobility procedures, including radio measurements, cell selection/reselection, and handover are established in the various network protocols and may be employed by terminal devices and the radio access network in order to maintain strong radio access connections between each terminal device and the radio access network across any number of different radio access network scenarios.

In accordance with various aspects provided herein, a terminal device 102, 104, or a network access node 112 may generate telemetry data. As described before, telemetry data may include any type of data that may represent conditions of the network, characteristics associated to cells and/or user equipments (UEs), various performance metrics, etc., which are related to radio communication operations associated with terminal devices 102, 104 and network access nodes 110, 112 of the radio access network. In some examples, especially within recent developments in disaggregated radio access network architectures, such as O-RAN, another network node that is communicatively connected to a network access node 110, 112 may also generate the telemetry data. Illustratively, the telemetry data may include information representative of conditions of radio communication channels, such as Reference Signal Received Power (RSRP) measurements, RSRP reports, Channel State Information (CSI), etc.

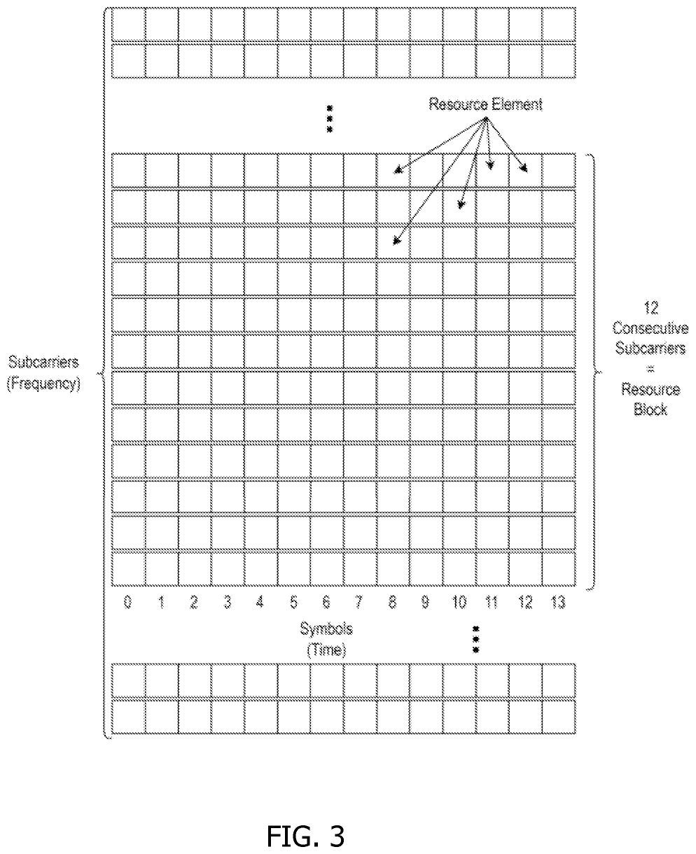

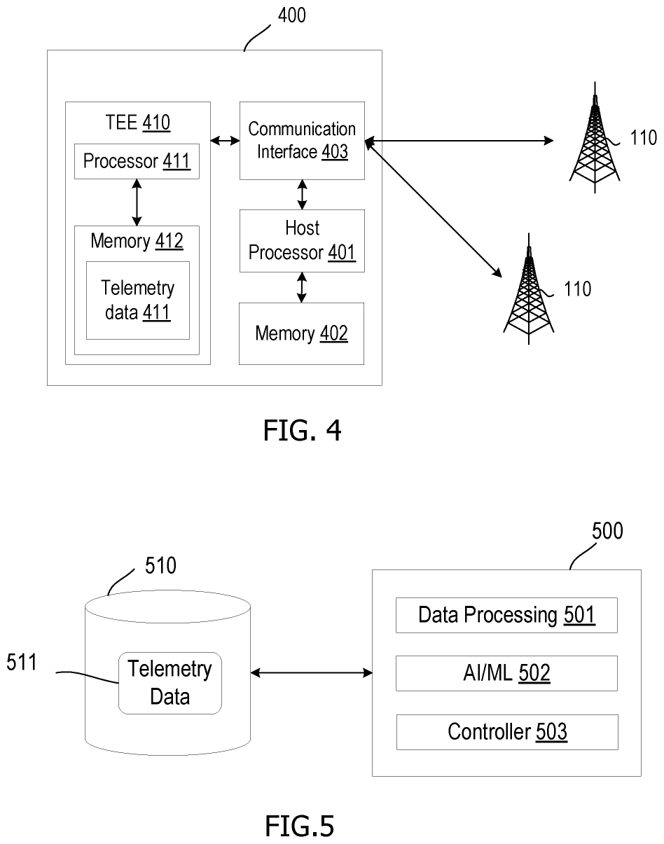

FIG. 3 shows an example of a resource grid. FIG. 4 shows an exemplary illustration of a resource grid for radio communication, complimenting the resource grid of LTE/5G. The resource grid represents time and frequency resources to perform radio communication, exemplarily in a radio access network. The smallest element corresponding to one time and frequency resource may be referred to as a resource element. Illustratively, in 5G/NR a resource element corresponds to one subcarrier during one OFDM symbol.

A resource block may be defined as 12 consecutive subcarriers in the frequency domain. It is to be considered that, resource block may sometimes be referred to as a physical resource block. To describe time domain limitations of a resource block, further considerations may be made, but minimum time domain length of a resource block can be one OFDM symbol duration. Consecutive 14 OFDM symbols may be referred to as a slot.

It is to be noted that, resource elements including reference signals are generally known due to requirements of wireless specifications. This may also be considered as a risk, as through jamming attacks focused on particular resource elements expected to carry reference signals, an adversary entity may deliberately adjust channel measurements used in AI/ML-based applications.

FIG. 4 shows an example of a device 400 according to various examples in this disclosure. The device 400 may be a device of a mobile communication network, which the device 400 may obtain data from one or more network access nodes (e.g. network access node 110). The device 400 is depicted as a communication device in this illustrative example, including a processor 401, a memory 402, and a communication interface 403 configured to receive and transmit communication signals in order to communicate with further entities within the mobile communication network.

Illustratively, the device 400 may be a device of an entity of the mobile communication network. In some examples, the device 400 may be a device implementing a network node of a disaggregated radio network architecture. The device 400 may illustratively implement an Open Radio Access Network (O-RAN) Distributed Unit (O-DU), or an O-RAN centralized unit (O-CU). In various aspects, the device 400 may implement a RAN intelligent controller (RIC), such as a real-time RIC (RT-RIC) or a non-real-time RIC (non-RT-RIC). In some examples, the device 400 may be a device of a network access node that may generate the telemetry data 411.

The communication interface 403 may include one or more transceivers configured to communicate with various entities within the network over designated interfaces. In particular, the communication interface 403 may be configured to receive and send communication signals carrying data received from another entity within the network, which the data may include data sent by a network access node (e.g. network access node 110, 112). In accordance with various aspects provided herein, the communication interface 403 may be configured to receive telemetry data 411 sourced by the network access node.

The host processor 401 may include one or more processors, which may include a baseband processor and an application processor. In various examples, the host processor 401 may include a central processing unit, a graphics processing unit, a hardware acceleration unit (e.g. one or more dedicated hardware accelerator circuits (e.g., ASICs, FPGAs, and other hardware)), a neuromorphic chip, and/or a controller. The host processor 401 may be implemented in one processing unit, e.g. a system on chip (SOC), or a processor. In accordance with various examples, the host processor 401 may further provide further functions to process received communication signals. The memory 402 may store various types of information required for the host processor 401, or the communication interface 403 to operate in accordance with various aspects of this disclosure.

The host processor 401 may perform various operations associated with the radio access network, which are designated for the device 400. Illustratively, the host processor 401 may implement designated functions of the protocol stack. For example, in a disaggregated radio access network architecture, the host processor 401 may implement medium access layer functions, radio link layer functions, etc.

In accordance with various aspects provided herein, the host processor 401 may further implement one or more AI/ML models, which are used to determine various parameters, perform various classification, and/or output decisions that are associated with the mobile communication network. In some examples, the host processor 401 may implement various application programming interfaces to interact with various applications stored in the memory 402 and implemented by the host processor 401.

Illustratively, the host processor 401 may implement various applications that are referred to as xApps. The term xApps may refer to applications or software components that are designed to operate within an open and programmable RAN architecture. The “x” in xApps represents the flexibility and extensibility of these applications, indicating that such applications may cover various functions or services within the RAN environment. These applications may be developed using open interfaces and standardized APIs (Application Programming Interfaces) that allow them to interact with different network elements and perform various functionalities within the RAN.

Illustratively, xApps may include Radio Resource Management (RRM) xApps, which may focus on managing and optimizing radio resources, including tasks like interference mitigation, spectrum management, and load balancing across base stations. Additionally, or alternatively, xApps may include Network Optimization xApps, which may be configured to analyze network performance, predict traffic patterns, and optimize parameters to enhance overall network efficiency and quality of service. Additionally, or alternatively, xApps may include Radio Access Control (RAC) xApps which may be configured to control access to the radio resources to ensure proper authentication, authorization, and security of devices connecting to the RAN. Additionally, or alternatively, xApps may include Traffic Steering xApps which may be configured to intelligently direct traffic flows based on network conditions, user demands, or service priorities, optimizing the use of available resources.

It is to be noted that although various xApps indicated herein may use telemetry data 411 as described for various aspects of this disclosure, the host processor 401 may also implement such xApps as alternatives. The xApps may operate on top of an open and programmable RAN infrastructure to provide flexibility for network operators to introduce new functionalities, services, or optimizations without being tightly bound to proprietary solutions from a single vendor. They may contribute to the evolution of RAN architectures toward more agile, customizable, and interoperable networks, fostering innovation and efficiency in the deployment and management of wireless networks.

However, it is further to be noted that, conventionally, such xApps may also be intended to operate, without particular constraints, tests, and/or security aspects with designated scrutiny. Operators, or other responsible parties may designate which xApps to be used, without particular concern to security and authenticity. Various aspects provided herein may be implemented to ensure that other xApps executed by the host processor 401 may not affect operation of the ML-based application by potentially malicious attacks or attempts and/or telemetry data 411.

The memory 402 may be configured to store data related to the operation of the device 400, and particularly encrypted telemetry data received from. The host processor 401 may have obtained various data based on its operations by communicating with the network access nodes via the communication interface 403. The operations of the device 400 may include that each network access node provides some data representative of network conditions, network operations, etc., which the network access nodes serve terminal devices within the plurality of cells. In some examples, the host processor 401 may have obtained encrypted telemetry data from another entity (e.g. another device) within the mobile communication network, which the another entity may communicate with the network access nodes. In some examples, the host processor 401 may also receive a further telemetry data used for other operations and/or xApps that is not encrypted as described herein.

In some aspects, the device 400 may be an entity of the mobile communication network of a disaggregated RAN architecture, which the device 400 may communicate with the network access nodes. In some aspects, within O-RAN context, the device 400 may include a RIC, such as a near real-time RIC or a non-real-time RIC. In other words, the device 400 may be a device that may implement aspects of near-RT-RIC or non-RT-RIC. Accordingly, the host processor 401 may implement various operations of a near-RT-RIC or a non-RT-RIC, and the memory 402 may store data required to perform near-RT-RIC or non-RT-RIC operations, some of which are described in this disclosure.

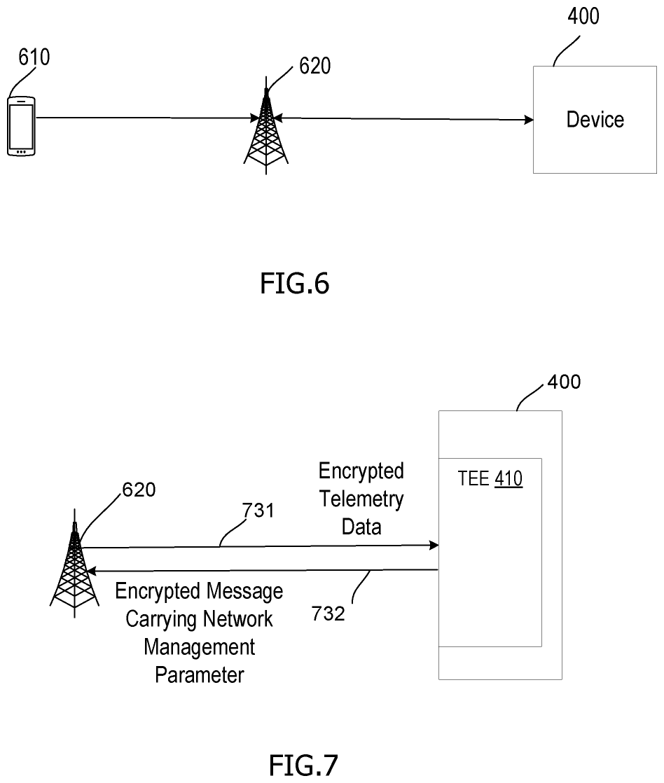

In accordance with various aspects provided herein, the device may further include an apparatus comprising a trusted execution environment (TEE). A TEE may be considered as a secure area designated within the device 400, which may provide confidentiality and protection to stored and processed data and information in a secure area. Illustratively, the TEE may include a processor 411. The processor 411 may be configured to provide an isolated processing environment, that is isolated from processing operations outside of the TEE, illustratively isolated from processing operations of the host processor 401. In some examples, the TEE illustrated herein may operate at a hardware level, distinct from the host processor 401 and the operating system which the host processor 401 may execute, as described in this disclosure. In some examples, the TEE may include a hardware Trusted Platform Module (TPM), as described in aspects associated with FIG. 6.

The processor 401 may include one or more processors. In various examples, the processor 411 may include a central processing unit, a graphics processing unit, a hardware acceleration unit (e.g. one or more dedicated hardware accelerator circuits (e.g., ASICs, FPGAs, and other hardware)), a neuromorphic chip, and/or a controller. The processor 411 may be implemented in one processing unit, e.g. a system on chip (SOC), or a processor. In accordance with various aspects, the processor 411 may actually be a portion of the hardware that implements the host processor 401, that is isolated from the host processor. In some examples, the processor 411 may be a hardware that is different from the hardware of the host processor 401.

Through the isolation of the processor 411, the processor 411 may provide a protected, confidential, and secure environment to process data, for illustratively sensitive computations, cryptographic operations, and other security-critical tasks that can be performed without being exposed to the rest of the system. This isolation may prevent unauthorized access and manipulation of data and code within the TEE. Illustratively, the TEE may be configured to provide security and isolation from other processing entities and data sources on the device 400 that are outside the TEE, such as, for example, software or applications (e.g. xApps) implemented by the host processor 401.

Furthermore, the TEE may include a secure memory 412. The secure memory 412 may only be accessible by the processor 411 within the TEE. Illustratively, the secure memory 412 may be provided on a hardware that is different from the memory 402. In this context, the memory 402 may also be referred to as a shared memory. In some examples, the secure memory 412 and the memory 402 may be provided on the same hardware, with particular isolation mechanisms implemented through hardware and/or software operations. In some examples, the processor 411 and the secure memory 412 may also be referred to as an enclave or a secure enclave.

Although it may have certain challenges due to the resource constraints and limitations of the TEE environment, implementation of an AI/ML model within a trusted execution environment (TEE) may be possible, in particular within the context of RAN-related decisions, RRM operations, traffic steering, etc., to prevent potential tampering of input data or operation of the AI/ML model. It is to be noted that TEEs are evolving to accommodate more complex computations, including AI/ML tasks, while ensuring security and confidentiality.

Illustratively, the processor 411 may execute ML-based application including the AI/ML model and associated computations within the TEE. For example, the processor 411 may load the model and any necessary data, such as input data of the AI/ML model into the enclave's protected memory. There may be certain resource limitations, yet the AI/ML model may be particularly designated to operate within limited resources and the processor 411 may perform inference and/or prediction tasks associated to the AI/ML model. The processor 411 may further implement APIs and/or SDKs (Software Development Kits) to create ML-based applications that can leverage the secure enclave.

In accordance with various aspects provided herein, the processor 411 may be configured to execute an ML-based application. As it may be desired to provide a secure and isolated environment for the ML-based application, to prevent potential harmful effects and tampering of other components of the device 400 outside of the TEE on the AI/ML model and its inference. The ML-based application may be configured to generate an output based on input data and the ML-based application may receive the telemetry data 411 as input to obtain the input data. The telemetry data 411 may be representative of telemetry data 411, illustratively representing one or more channel measurements such as RSRP, measured and/or collected by a terminal device.

An ML-based application may refer to a software application, which the processor 411 may implement, that may utilize AI/ML techniques and algorithms (i.e. an AI/ML model) to perform specific tasks and make determinations. In particular, in the context of this disclosure, an AI/ML-based application may include a trained AI/ML model that is configured to receive input data based on the telemetry data 411, and provide an output that is related to a management of a radio access network.

Illustratively, the output may include a parameter associated with an aspect of the radio access network (i.e. a network management parameter). For example, the output may include a parameter of a beamforming operation to be performed by a network access node or a terminal device associated with the telemetry data 411. For example, the output may include a parameter associated with network traffic management of the network access node or the terminal device, such as a QoS parameter or a scheduling information. For example, the output may include a parameter that indicates whether a handover operation is performed for the terminal device. For example, the output may include a parameter indicative of an antenna configuration for the terminal device or the network access node. For example, the output may include a parameter representing a MIMO transmission mode, etc.

FIG. 5 shows an example of a processor and a memory of a device according to various aspects provided in this disclosure. The processor 500 is depicted to include various functional units that are configured to provide various functions as disclosed herein, associated with a processor that may be used within a device (e.g. the device 400). The skilled person would recognize that the depicted functional units are provided to explain various operations that the processor 500 may be configured to perform.

Similarly, the memory 510 (e.g. the memory 412) is depicted to include the telemetry data 511 (e.g. the telemetry data 405) as a block, however, the memory 510 may store the telemetry data 511 in any kind of suitable configuration or mechanism. In some aspects, the telemetry data 511 may be channel measurements performed and transmitted by a communication device (e.g. communication device 200) incorporating the features of a terminal device (e.g. terminal device 102) to a network access node (e.g. network access node 110). In some examples, the measurements may be preprocessed measurements by a processing entity of the network access node or by another intermediary entity that is between the network access node and the device. Channel measurements may particularly include reference signal received power (RSRP) measurements, channel state information (CSI), etc. A network node (e.g. network node 110) may receive the measurements forming the telemetry data and may perform data preprocessing techniques (e.g. quantization) on the telemetry data. However, the telemetry data stored in the memory 510 may or may not be subject to preprocessing prior to being stored in the memory 510.

In accordance with various aspects provided herein, the processor 500 and the memory 510 may be implemented within a TEE (e.g. so that the processor 410 and the memory 411 may correspond to the processor 500 and the memory 510). The processor 500 and the memory 510 may be configured to form a TEE that is isolated from other components of the device including the TEE. The TEE and correspondingly the device may implement any known methods to provide such isolated processing environment.

On the other hand, in accordance with various aspects provided herein, the processor 500 and the memory 510 may be implemented in a device (e.g. the device 400), but not within a TEE. In particular, with respect to examples associated with detection of jamming attacks, the aspects provided herein may be implemented, illustratively, within a non-secure environment (i.e. so that the processor 401 and the memory 402 may correspond to the processor 500 and the memory 510).

Furthermore, the AI/ML unit 502 is depicted as it is implemented in the processor 500 only as an example, and any type of AI/ML implementation which may include the implementation of the AI/ML in an external processor, such as an accelerator, a graphics processing unit (GPU), a neuromorphic chip, or in a cloud computing device, or in an external processing device may also be possible according to any methods.

The processor 500 may include a data processing unit 501 that is configured to process data and obtain input data for the AI/ML unit based on the telemetry data 511 as provided in various examples in this disclosure to be stored in the memory 510. In various examples, the telemetry data 511 may include not only current but also past information for at least within a period of time in a plurality of instances of time (e.g. as a time-series data). The telemetry data 511 stored in the memory 510, may include preprocessed data based on received stream of data. In some aspects, the data processing unit 501 may perform feature extraction techniques on the telemetry data 511 to obtain the input data. The data processing unit 501 may be configured to process corresponding telemetry data 511 of respective cells received from respective network access nodes.

The data processing unit 501 may implement various preprocessing operations to obtain the telemetry data 511 and/or the cell data 712. Such operations may include cleaning the telemetry data by removing outliers, handling of missing parameters, correcting errors or inconsistencies, and such. Operations may further include data normalizations in order to scale the telemetry data 511 to a common range. Operations may further include data transformation including mapping the telemetry data 511 based on predefined mapping operations corresponding to mathematical functions to map one or more data items of the telemetry data 511 to a mapped data time for the purpose of analysis.

The data processing unit 501 may be configured to generate training dataset based on the telemetry data 511. In other words, based output of the AI/ML unit 502 in response to the input data, the data processing unit 501 may prepare the training data to be used in the training of the AI/ML. The generation of the training dataset may include aggregating the telemetry data 511 received from multiple network access nodes or received in multiple time periods. The data processing unit 501 may be configured to apply data fusion techniques to aggregate data. Data fusion may be considered as a process of integrating and combining data, within this context, by combining the telemetry data 511 to obtain a unified dataset representative of the RAN environment.

The data processing unit 501 may further implement feature extraction operations. It is to be considered that the AI/ML implemented by the AI/ML unit may have certain constraints, some of which may relate to the structure and aspects of the data to be inputted to the AI/ML. The feature extraction operations may include translating (i.e. transforming) the telemetry data 511 into input data of the AI/ML. The feature extraction operations may further include generation of training input data for the training dataset based on the telemetry data 511. In some aspects, the feature extraction operations may be based on model information representing the attributes to be used as the input of the AI/ML, relative importance or weights of the attributes, etc. The feature extraction operations may include reducing the number of attributes (i.e. data items from the telemetry data 511) to be used, ranking of the attributes, etc. based on the model information.

In some aspects, the telemetry data 511 may include information representative of annotations and/or labels to be used for training. In some aspects, the data processing unit 501 may also assign labels or assign ground truth values for the generated training data for the generation of the training dataset. In some aspects, the data processing unit 501 may further generate annotations for the generation of the training data set. Generation of annotations and/or labels may be according to supervised training inputs, or may be based on unsupervised methods, exemplarily by an implementation of an automatized model to assign the labels and/or the annotations.

For supervised learning, generation of labels and annotations may require domain expertise and an understanding of the specific tasks that the AI/ML is designed to address. For example, a human expert might need to review network logs and performance data to identify instances of network congestion, which could then be labeled as positive or negative examples for a congestion prediction model. In some cases, semi-supervised or unsupervised learning techniques can be used to reduce the reliance on labeled data and leverage the vast amounts of unlabeled data available in the RAN. These approaches may involve clustering, anomaly detection, or other methods that can identify patterns and relationships in the data without explicit ground truth labels.

Accordingly, the data processing unit 501 may generate the training dataset based on the telemetry data 511. It is to be noted that the AI/ML unit 502 may use the training dataset in predefined portions, namely a first portion of the training data set for training, a second portion of the training dataset for validation and a third portion of the training dataset for testing purposes. The AI/ML unit 502 may use the first portion to train the AI/ML, which may allow the AI/ML to learn the underlying patterns and relationships in the data. The AI/ML unit 502 may use the second portion to evaluate and fine-tune the AI/ML during the training process, which may help to prevent overfitting and improve generalization. Finally, the AI/ML unit 502 may use the third portion to assess the performance of the trained AI/ML and provide an unbiased estimate of their accuracy and effectiveness for AI/ML tasks.

The AI/ML unit 502 may implement one or more AI/MLs. The aspects are provided for one AI/ML but it may also include applications involving more than one AI/MLs. The AI/ML may be configured to receive input data with certain constraints, features, and formats. Accordingly, the data processing unit 501 may obtain input data, that is based on the telemetry data 511, to be provided to the AI/ML to obtain an output of the AI/ML. In various examples, the data processing unit 501 may provide input data including the telemetry data 511 to the AI/ML. The input data may include attributes of the telemetry data 511 associated with a period of time or a plurality of consecutive periods of time. In various examples, the data processing unit 501 may convert the telemetry data 511 to an input format suitable for the AI/ML (i.e. feature extraction e.g. to input feature vectors) so that the AI/ML may process the telemetry data 511.

The processor 500 may further include a controller 503 to control the AI/ML unit 502. The controller 503 may provide the input data to the AI/ML, or provide the AI/ML unit 502 instructions to obtain the output. The controller 503 may further be configured to perform further operations of the processor 500 in accordance with various aspects of this disclosure.

The AI/ML may be any type of machine learning model configured to receive the input data and provide an output as provided in this disclosure. The AI/ML may stand for the ML-based application provided in the disclosure. The AI/ML may include any type of machine learning model suitable for the purpose. The AI/ML may include a decision tree model or a rule-based model suitable for various aspects provided herein. The AI/ML may include a neural network. The neural network may be any type of artificial neural network. The neural network may include any number of layers, including an input layer to receive the input data, an output layer to provide the output data. A number of layers may be provided between the input layer and the output layer (e.g. hidden layers). The training of the neural network (e.g., adapting the layers of the neural network, adjusting Model parameters) may use or may be based on any kind of training principle, such as backpropagation (e.g., using the backpropagation algorithm).

For example, the neural network may be a feed-forward neural network in which the information is transferred from lower layers of the neural network close to the input to higher layers of the neural network close to the output. Each layer may include neurons that receive input from a previous layer and provide an output to a next layer based on certain AI/ML (e.g. weights) parameters adjusting the input information.

The AI/ML may include a recurrent neural network in which neurons transfer the information in a configuration in which the neurons may transfer the input information to a neuron of the same layer. Recurrent neural networks (RNNs) may help to identify patterns between a plurality of input sequences, and accordingly, RNNs may be used to identify, in particular, a temporal pattern provided with time-series data and perform estimations based on the identified temporal patterns. In various examples of RNNs, long short-term memory (LSTM) architecture may be implemented. The LSTM networks may be helpful to perform classifications, and processing, and estimations using time series data.

An LSTM network may include a network of LSTM cells that may process the attributes provided for an instance of time as input data, such as attributes provided for the instance of time, and one or more previous outputs of the LSTM that have taken in place in previous instances of time, and accordingly, obtain the output data. The number of the one or more previous inputs may be defined by a window size, and the weights associated with each previous input may be configured separately. The window size may be arranged according to the processing, memory, and time constraints and the input data. The LSTM network may process the features of the received raw data and determine a label for an attribute for each instance of time according to the features. The output data may include or represent a label associated with the input data.

In various examples, the neural network may be configured in top-down configuration in which a neuron of a layer provides output to a neuron of a lower layer, which may help to discriminate certain features of an input.

In accordance with various aspects, the AI/ML may include a reinforcement learning model. The reinforcement learning model may be modeled as a Markov decision process (MDP). The MDP may determine an action from an action set based on a previous observation which may be referred to as a state. In a next state, the MDP may determine a reward based on the current state that may be based on current observations and the previous observations associated with previous state. The determined action may influence the probability of the MDP to move into the next state. Accordingly, the MDP may obtain a function that maps the current state to an action to be determined with the purpose of maximizing the rewards. Accordingly, input data for a reinforcement learning model may include information representing a state, and an output data may include information representing an action.

Reinforcement learning (RL) is a type of machine learning that focuses on training an agent to make decisions by interacting with an environment. The agent learns to perform actions to achieve a goal by receiving feedback in the form of rewards or penalties. As a machine learning model, reinforcement learning models learn from data (in this case, the agent's experiences and interactions with the environment) to adapt their behavior and improve their performance over time. Since machine learning is a subset of AI, reinforcement learning models are also considered AI models, as they aim to perform tasks that require human-like decision-making capabilities.

The AI/ML may include a convolutional neural network (CNN), which is an example for feed-forward neural networks that may be used for the purpose of this disclosure, in which one or more of the hidden layers of the neural network include one or more convolutional layers that perform convolutions for their received input from a lower layer. The CNNs may be helpful for pattern recognition and classification operations. The CNN may further include pooling layers, fully connected layers, and normalization layers.

The AI/ML may include a generative neural network. The generative neural network may process input data in order to generate new sets, hence the output data may include new sets of data according to the purpose of the AI/ML. In various examples, the AI/ML may include a generative adversarial network (GAN) model in which a discrimination function is included with the generation function, and while the generation function may generate the data according to model parameters of the generation function and the input data, the discrimination function may distinguish the data generated by the generation function in terms of data distribution according to model parameters of the discrimination function. In accordance with various aspects of this disclosure, a GAN may include a deconvolutional neural network for the generation function and a CNN for the discrimination function. The AI/ML may include a trained AI/ML that is configured to provide the output as provided in various examples in this disclosure based on the input data and one or more Model parameters obtained by the training. The trained AI/ML may be obtained via an online and/or offline training. A training agent may perform various operations with respect to the training at various aspects, including online training, offline training, and optimizations based on the inference results. The AI/ML may take any suitable form or utilize any suitable technique for training process. For example, the AI/ML may be trained using supervised learning, semi-supervised learning, unsupervised learning, or reinforcement learning techniques.

In supervised learning, the AI/ML may be obtained using a training dataset including both inputs and corresponding desired outputs (illustratively, input data may be associated with a desired or expected output for that input data). Each training instance may include one or more input data item and a desired output. The training agent may train the AI/ML based on iterations through training instances and using an objective function to teach the AI/ML to estimate the output for new inputs (illustratively, for inputs not included in the training set). In semi-supervised learning, a portion of the inputs in the training set may be missing the respective desired outputs (e.g., one or more inputs may not be associated with any desired or expected output).

In unsupervised learning, the model may be built from a training dataset including only inputs and no desired outputs. The unsupervised model may be used to find structure in the data (e.g., grouping or clustering of data points), illustratively, by discovering patterns in the data. Techniques that may be implemented in an unsupervised learning model may include, e.g., self-organizing maps, nearest-neighbor mapping, k-means clustering, and singular value decomposition.

Reinforcement learning models may include positive feedback (also referred to as reward) or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

The training agent may adjust the Model parameters of the respective model based on outputs and inputs (i.e. output data and input data). The training agent may train the AI/ML according to the desired outcome. The training agent may provide the training data to the AI/ML to train the AI/ML. In various examples, the processor and/or the AI/ML unit itself may include the training agent, or another entity that may be communicatively coupled to the processor may include the training agent and provide the training data to the device, so that the processor may train the AI/ML.

In various examples, the device may include the AI/ML in a configuration that it is already trained (e.g. the Model parameters in a memory are already set for the purpose). It may desirable for the AI/ML itself to have the training agent, or a portion of the training agent, in order to perform optimizations according to the output of inferences as provided in this disclosure. The AI/ML may include an execution unit and a training unit that may implement the training agent as provided in this disclosure for other examples. In accordance with various examples, the training agent may train the AI/ML based on a simulated environment that is controlled by the training agent according to similar considerations and constraints of the deployment environment.

For example, the training dataset may include training input data based on telemetry data 511, which may include information about telemetry data representative of one or more attributes (e.g. RSRP measurements) described in this disclosure. Training input data may further include training output data associated with the training input data representing desired outcomes with respect to each set of training input data. Training output data may indicate, or may represent, the desired outcome with respect to training input data, so that the training agent may provide necessary adjustments to respective Model parameters in consideration of the desired outcome. In some aspects, the training output data may include labels and annotations as described here.

The skilled person would immediately recognize that the exemplary AI/ML disclosed herein is explained that may have many configurations. In a least complex scenario, for execution of the AI/ML (i.e. inference), the AI/ML may be configured to provide an RRM output parameter to be used by the plurality of cells. The input data of the AI/ML may include one or more attributes of one or more cells provided in the telemetry data 511. The AI/ML may map the input data to a corresponding RRM output parameter, which the mapping would be based on model parameters of the AI/ML. For training of the AI/ML, the training agent may train the AI/ML by providing training input data of the generated training dataset to the input of the AI/ML and it may adjust model parameters of the AI/ML based on the output of the AI/ML that is mapped according to the training input data, and training output data of the training dataset (e.g. labels, annotations) associated with the provided training input data with an intention to make the output of the AI/ML more accurate. Accordingly, the training agent may adjust one or more model parameters based on a calculation including parameters for the output of the AI/ML for the training input data and the training output data associated with the training input data. In various examples, the calculation may also include one or more parameters of the AI/ML. With each iteration with respect to the training input data that may include many data items, which each data item may represent an input of an instance (of time, of observation, etc.) on various aspects and each iteration may iterate a respective data item representing an input of an instance, the training agent may accordingly cause the AI/ML to provide more accurate output through adjustments made in the model parameters.

The processor 500 may implement the training agent, or another entity that may be communicatively coupled to the processor 500 may include the training agent and provide the training input data to the device, so that the processor 500 may train the AI/ML. The training agent may be part of the AI/ML unit 502 described herein. Furthermore, the controller 503 may control the AI/ML unit 502 according to a predefined event. For example, the controller 503 may provide instructions to the AI/ML unit 502 to perform the inference and/or training in response to a received request from another entity. The controller 503 may further obtain output of the AI/ML from the AI/ML unit 502.

In accordance with some of the aspects provided herein, the controller 503 may control the AI/ML unit 502 to selectively cause the AI/ML to be trained in a first operation mode and a second operation mode. In the first operation mode, the training agent (e.g. the AI/ML unit 502) may cause the AI/ML to be trained with a first training dataset that is generated, which the first training dataset includes the telemetry data 511 and/or the cell data 712 of only the selected subset cells of the plurality cells. In the second operation mode, the training agent (e.g. the AI/ML unit 502) may cause the AI/ML to be trained with a second training dataset including the telemetry data 511 and/or the cell data 712 of at least one cell of the plurality of cells, which the at least one cell is not within the selected subset cells. In accordance with the operation mode, the data processing unit 501 may perform necessary operations to generate respective training datasets. The data processing unit 501 may generate the second training dataset in accordance with known methods by aggregating the telemetry data 511 for the plurality of cells (i.e. the second training dataset includes aggregated data of all of the plurality of cells), or selectively by aggregating the telemetry data 511 of a selection of the cells, which the selection of the cells includes at least one cell is not within the selected subset cells.

In accordance with various aspects provided herein, the controller 503 may further include a secure manager to perform various operations to manage operations of the TEE. Illustratively, the controller 503 may manage and oversee operations performed within the TEE by performing various security-related functions to ensure integrity and proper functioning of the TEE. The controller 503 may handle creation, initialization, and termination of secure enclaves within the TEE. The controller 503 may manage enclave instances to perform a task, such as an inference of an ML-based application. The controller 503 may further perform inter-device communication operations to facilitate a secure communication between the enclave and the device (i.e. other components of the device, e.g., the host processor 401). In some example, the controller 503 may implement, and perform designated monitoring for various access control policies within the TEE to ensure that only authorized entities or processes can access the resources of the TEE, such as telemetry data, input and output data of the ML-based application, or cryptographic keys. It might handle authentication mechanisms to verify identities. In some examples, the controller 503 may also perform management of resources allocated to perform designated tasks within the TEE.

In accordance with various aspects provided herein, the controller may enforce designated policies and measures associated with the security within the TEE, such as protection against various attacks, including side-channel attacks, memory-based attacks, or tampering attempts. Furthermore, the TEE may support remote attestation mechanisms to allow external systems or entities, such as the source of the telemetry data, the network access node, etc. to verify the integrity and security state of the TEE. For this purpose, the controller 503 may generate evidence that the TEE is in a trusted and properly configured state and instruct to send the evidence to a desired entity.

FIG. 6 illustrates an exemplary illustration of an information flow in accordance with various aspects of the disclosure. A terminal device 610, such as the terminal device 102, may measure and/or collect information for generation of the telemetry data, illustratively including channel information such as channel state information (CSI), received signal reference power (RSRP), etc. The terminal device 610 may transmit information that may represent various metrics of the radio access network and/or that may represent user behavior for the terminal device to a network access node via a wireless communication technology which may, among other ways, cellular communication such as 5G. In some examples, the network access node may be a network access node 620 (e.g. a base station).

A processor of the network access node 620 may perform processing on the information received from the terminal device, and possibly also from other terminal devices to which the network access node 620 may provide a network service, to obtain telemetry data. The processor of the network access node 620 may perform various types of preprocessing that may include any preprocessing techniques suitable for performing on the data. The preprocessing may include quantization of the telemetry data, scaling of the telemetry data, and the like. It is to be noted that the preprocessing performed by the network access node 620 may not necessarily be final and the telemetry data may further be preprocessed by the processor 411, if required.

It is to be noted that FIG. 6 has been illustrated to include only one node between the terminal device 610 and the device 400, which is the network access node 620. However, in various radio access network architectures, there may be further intermediary nodes between the network access node 620 and the device 400. For example, in O-RAN architecture or a similar disaggregated network architecture, more than one network access nodes 520 may be involved. Illustratively, the terminal device 610 may send and/or receive radio communication signals to an O-RU which performs a first portion processing of the network stack. The O-RU may communicate with an O-DU which performs a second portion processing of the network stack. O-DU may further communicate with an O-CU which performs a third portion processing of the network stack. In this exemplary illustration, the source of the telemetry data, (i.e. the network access node 620) may, for example, be O-DU and/or O-CU.

The processor 411 may receive the telemetry data, and the processor 411 may execute the ML-based application in which the telemetry data is used as the input. The processor 411 may transmit the output of the ML-based application including relevant parameters relating to network management back to the network access node 620 (e.g. the base station). In an example, the network management may include handover management.

The device 400 in which processor 411 may execute the ML-based application may include other software and/or hardware components that may be malicious and may tamper with telemetry data to cause the ML-based application to generate an output that is suboptimal, erroneous and/or inferior with respect to predefined criteria, so that the network management parameters obtained from the output may lead to corresponding suboptimal actions and/or operations taken by the network access node 620. In some cases, network management parameters derived from the output may cause the network access node 620 to initiate an early handover, a late handover, a handover to a further network access node that is suboptimal, etc. due to the output is based on the tampered input data. As a result, QoE, QoS and other metrics may degrade for a user of the corresponding terminal device 610. The telemetry data being tampered with may be a risk caused by the components sharing the same infrastructure within the apparatus. The components may include hardware and/or software-based components, such as the operating system.

In this regard, confidential computing may be utilized to prevent inference from malicious hardware and/or software components which reside on the device 400 or another node that may access a relevant entity associated with the telemetry data and/or the ML-based application. To triumph over this, the device 400 may include a trusted execution environment (TEE). The processor 411 may perform operations, such as executing the ML-based application within the TEE. In that sense, the apparatus may provide via TEE a secure and isolated area for the processor 411 performing operations, making it difficult for attackers to intervene in the processes run in the environment.

FIG. 7 illustrates an exemplary association between a device and a network access node. The device 400 may include a TEE 410 for executing one or more trusted applications. The TEE 410 may exemplarily be Intel's SGX secure enclave. As denoted, the device 400 may include a number of applications and/or components that may or may not be malicious. In various aspects provided herein, the ML-based application may rely on the telemetry data received from one or more network nodes controlled by a corresponding network operator. In other words, the AI/ML of the ML-based application may perform operations based on the telemetry data.

In various aspects, in order to ensure that the telemetry data has not been tempered with during the journey between the network access node and the TEE 410, a processor of the network access node 620 may encrypt the telemetry data prior to sending the telemetry data to the device 400. The processor of the network access node 620 may implement any known cryptographic methods for encryption of the telemetry data. Illustratively, the encryption may be performed by using cryptographic keys shared in a designated manner between the network access node 620 and the device 4400.

For example, the cryptographic keys may include symmetric keys, which the processor of the network access node 620 and the processor 411 may use a single shared key to both encrypt data exchanged between them, such as the telemetry data. For example, in an asymmetric key approach, each of the processor of the network access node 620 and the processor 411 may generate a corresponding public key and a private key. When the processor of the network access node 620 encrypts data, it may use the public key of the processor 411. Similarly, when the processor 411 encrypts data, it may use the public key of the processor of the network access node 620. Each of the processor of the network access node 620 and the processor 411 may use their respective private keys to decrypt encrypted data received from the other.

Illustratively, the network access node 620 may provide a decryption key to the processor 411, for example to ML-based application or a trusted application within the TEE 410. The decryption key may be used for decryption of the encrypted telemetry data 631. In this example, the decryption key may include a shared cryptographic key. In another example, the processor 411 may generate a shared cryptographic key and send information representing the shared cryptographic key which the processor of the network access node 620 may use to encrypt the telemetry data.

In another example, the processor 411 may generate an encryption key (e.g. public key) and a decryption key (e.g. private key) that are asymmetric, and the processor 411 may send the encryption key to the network access node 620, which the processor of the network access node 620 may use that encryption key to encrypt the telemetry data. The processor 411 may decrypt received encrypted telemetry data using the decryption key. Similarly, the processor of the network access node 620 may generate a further encryption key (e.g. public key) and a further decryption key (e.g. private key) that are asymmetric, and the network access node 620 may send the encryption key to the apparatus, which the processor 411 may use that further encryption key to encrypt data for transmission to the network access node 620. The processor of the network access node 620 may decrypt received encrypted data using the further decryption key.

The processor 411 may decrypt the telemetry data from the network access node 620 using a corresponding decryption key. Upon decryption, the processor 411 may provide the decrypted data (i.e. telemetry data) for processing of the ML-based application. Alternatively, the processor 411 may store the telemetry data in the memory 412. The processor 411 may generate input data for the AI/ML of the ML-based application based on the telemetry data, as illustratively described in accordance with FIG. 5.

The output may comprise decisions and/or instructions for network access node 620. The term decisions may include network management parameters based on which the corresponding network access node or any other network node may perform various operations (e.g. handover).

Furthermore, in order to ensure that the output of the ML-based application has not been tampered by any entity between the TEE 410 and a network node to which the processor 411 may encode a message based on the output of the ML-based application, the processor 411 may encrypt the message that is based on the output of the ML-based application within the TEE 410. The device 400 may accordingly transmit the encrypted message to the corresponding network node. Illustratively, the network node may be the network access node 620 that is the source of the telemetry data, and the processor 411 may use above-mentioned operations associated for the cryptographic keys to encrypt the message. In case the network node is another network node within the network, the processor 411 may perform the above-mentioned operations associated for the cryptographic keys with the corresponding network to identify cryptographic keys which the processor 411 may use to encrypt the message.

Illustratively, the network access node 620 may receive the encrypted output 632 and decrypt it with a corresponding cryptographic key to obtain the message. In some examples, the message may include information representing the output of the ML-based application. Based on the parameters stored in the output, the network access node 620 may perform one or more corresponding operation. In an example, the network access node 620 receiving the encrypted output 632 may initiate a handover, in that case the network access node may act as the source node.

Although prior parts of the disclosure illustrate that the terminal device 610 may collect and/or measure channel information forming the telemetry data, the telemetry data may also originate from different sources such as network access nodes (e.g. base stations). Thus, encryption of the telemetry data may be performed at different stages of the information flow. In an example, the network node 620 may, via a processing means, encrypt the telemetry data prior to sending the data to the apparatus 405 comprising the processor 411 within the TEE 410. In another example, the terminal device 610 may, via a processor, itself perform encryption using cryptographic keys on the measurements used as input for the ML-based application.

The cryptographic keys used to decrypt the telemetry data may not be accessible outside the TEE 410. In this case, the cryptographic key for decryption of the telemetry data may only be available within the TEE 410 to enhance security of the encrypted telemetry data 631 so that the applications/components that may reside in the device 400 cannot access the decryption key to decrypt the data which may otherwise result in tampering of the sensitive telemetry data, given that the applications/components are malicious or modified by an adversary to perturbate the data.

In some aspects, the processor 411 may encrypt the output to transmit the encrypted output 632 to a further network node. The encryption may be performed by using cryptographic key algorithms, such as private-public key pair. Therefore, the processor 411 may encrypt the output using a cryptographic key and may provide a decryption key to the further network node for decryption of the output to obtain network management parameters. The encryption key may be stored within the TEE 410. In that way, other potentially malicious components may not tamper with the output as they may not access the raw output (i.e. not encrypted) before the processor 411 performs the encryption of the output prior to transmitting it to a further network access node.

In some aspects, the ML-based model may be executed within the trusted nodes (e.g. near real-time RIC) of the network access node 620 of the O-RAN system. That approach may be useful when the network access node 620 needs to implement a time-sensitive operation based on the output of the ML-based application where the output includes network management parameters for the network access node 620. In this case, the apparatus 405 may reside in one or more trusted nodes of the network access node 620. The time sensitive operations may include beamforming, traffic management, handover management and the like.

In an example, the processor 411 may execute the ML-based application within a near real-time RAN intelligent controller (RIC) node of the network nodes pertinent to the network access node 620. As the ML-based application may share the same hardware with the other applications, the apparatus 405 may still need to include the TEE 410 for the processor 411 to perform the execution in a secure and isolated manner due to the other applications potentially being malicious. In that way, provided architecture may prevent the other applications including the operating system to tamper with the telemetry data. The trusted nodes of the network access node 620, other than the near real-time RIC, that may host the apparatus 405 include O-RAN distributed unit (O-DU) or O-RAN centralized unit (O-CU).

In accordance with various aspects described herein, the potential risk of tampered telemetry data resulting in disrupted output generated by the ML-based application may not necessarily stem from the malicious components/applications that reside within the device 400. The adversaries may also aim to attack the terminal device 610 (e.g., a user device, user equipment) or to the network access node 620 to spoil the original measurements exemplary by a malicious software. Additionally, or alternatively, they may disrupt the network access node 620 with a malware. Those attacks may eventually result in tampered and/or compromised telemetry data. Adversaries may also deploy rogue user devices and/or rogue network operators (e.g. rogue base stations) to run malicious activities.

In an example, a rogue network access node may mimic the behavior of a genuine network access node to interrupt the communication between the terminal device 610 and the communication network. In some cases, a deployed rogue network access node may interfere with the operations performed by the terminal device 610 to disrupt the data traffic. The operations may include known day-to-day activities, such as calls, text messages, etc. Those malicious activities may typically result in disrupted measurements which causes the telemetry data to be tampered with and/or manipulated.

A hardware-based authentication scheme may be provided to mitigate issues caused by the rogue user devices and/or the rogue network access nodes. Accordingly, the hardware-based authentication may ensure that the software and hardware configuration of a device are verified. In an example, the hardware-based authentication may refer to use of a trusted platform module (TPM). Network access nodes (e.g. base stations), such as the network access node 620, and terminal devices, such as the terminal device 610 measuring, collecting and/or providing telemetry data may include a hardware component specialized to provide proof of authentication of the corresponding network access node 620 and/or the terminal device 610. TPM may also ensure that hardware and/or software configurations of the respective network access node 620 and/or the terminal device 610 are valid.

In some cases, TPM may provide remote attestation in which a cryptographically signed hash may be used to verify the state of the hardware and/or software components of a corresponding network operator and/or the user device. In an example, TPM may provide remote attestation to the network operator or the user device where a cryptographically signed hash may be used to verify the state of hardware/software components of the network operator and/or the user device. The term “state” may refer to an unaltered and/or unmodified state of the hardware and/or software components indicating that the components are not subject to a change.

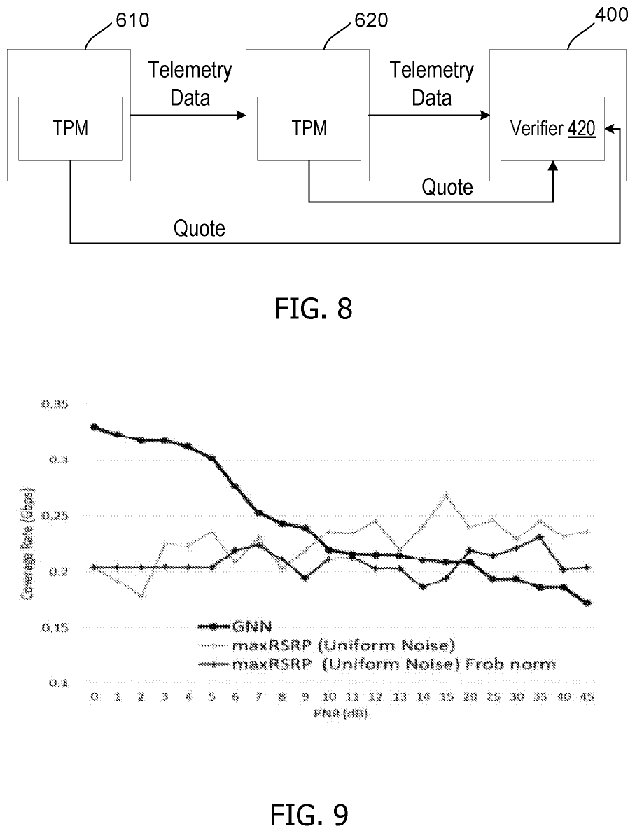

FIG. 8 shows an exemplary illustration of a network. In accordance with various aspects provided herein, the network access node 620 and/or the terminal device 610 may include a corresponding TPM. A TPM may include a controller that may be compatible with one or more TPM standards. The controller may secure hardware, software and/or data of a corresponding device including the TPM via cryptographic functions and secure storage. Illustratively, a TPM may be implemented by an integrated hardware component or a chip within the corresponding device.

In some aspects, the TPM may include a secure memory configured to store cryptographic keys, passwords, certificates, which the secure memory is isolated from a shared memory and may be protected against unauthorized access or tampering, similar to a TEE. The TPM may be configured to perform attestation operations to provide an evidence or proof of the integrity of the corresponding device to indicate that the corresponding device has not been compromised or altered.

The TPM may further include one or more attestation keys. The attestation keys may include cryptographic keys used for attestation purpose. The TPM may store the attestation keys in the secure memory. The one or more attestation keys may be generated via asymmetric cryptography keys, i.e. private-public key pairs. Illustratively, the TPM may store the private keys in the memory, with which the TPM may sign attestation data, which may include characteristic information associated with the corresponding device, such as measurements of boot process, configuration, and integrity data.

In some aspects, a verifier 420 may need to ensure the authenticity of the components of the network access node and/or the terminal device. The verifier 420 may be a network provider or the apparatus. Therefore, in some cases, the verifier 420 may be an entity in which the ML-based application is executed, such as the device 400. The verifier 420 (i.e., verifying entity) may request a digital certificate indicating the authenticity of the components from the network access node 620 and/or the terminal device 610. The network access node 620 and/or the terminal device 610 may provide the requested certificate whose state may be inquired using a certificate authority (CA). In some examples, the certificate may be a root CA which provides digitally signed certificates for entities to use them as a proof of authenticity.

Illustratively, the verifier 420 may include a processor (e.g. the host processor 401 or the processor 411) configured to verify an identity of the network access node 620 and/or the terminal device 610. In some examples, the processor may verify identities of other network nodes within the environment. The terminal device 610 and/or the network access node 620 may include their corresponding TPMs, and the processor may verify the identity of the corresponding device based on an attestation key, which may include a public key of a public-private key pair designated for attestation as described above. The processor may verify the identity of the corresponding device in accordance with the corresponding characteristic information associated with the TPM of the corresponding device.

In accordance with various aspects provided herein, the processor of the verifier 420 may identify and/or authenticate devices via quotes (i.e. TPM quotes). A quote may include a cryptographically signed characteristic information of a TPM, such as a hash value, which may illustratively be a platform configuration register (PCR) value (e.g. a secure hash digest). Illustratively, a TPM signing the characteristic information of the TPM (e.g. PCR value) with its private key of a public-private key pair of attestation may correspond to performing a quote. The processor of the verifier 420 may verify that a corresponding public key associated with a received quote corresponds to a corresponding device (e.g. the terminal device 610 or the network access node 620).

In accordance with various aspects provided herein, the requested certificate may be validated. Upon validation of the certificate, the verifier 420 (e.g. the apparatus 401) may send a query to the network access node 620 and/or the terminal device 610 to cause them to generate attestation keys within the TPM. Attestation keys may include public keys and private keys. TPM may generate a quote based on the attestation keys in which the quote may refer to a signed statement providing evidence that the hardware and/or software components of the network operator 620 and/or the terminal device 610 have a secure configuration. The phrase “secure configuration” here may refer to at least one of: unmodified, unaltered, unchanged or uncompromised configuration which ensures integrity.

The verifier 420 may receive the quote representing the integrity of the network access node 620 and/or the terminal device 610 as well as the public keys. Public keys may allow the verifier 420 to check whether the configurations match the expected values. The expected values representing information of a configuration may be stored in a memory that is accessible to the processor 411 of the verifier 420. The processor 411 may determine whether the configurations received from the network access node 620 and/or the terminal device 610 are in alignment with the configurations stored in the memory. The memory may be a non-volatile memory and the processor 411 may access the content stored in the memory.

In an example, the processor 411 may determine that the received configuration information is coherent with the information stored in the memory. In that case, the verifier 420, based on the determination, may authorize the corresponding network access node 620 and/or the terminal device 610 to communicate data. In another example, the processor 411 may determine that the received configuration information is not coherent with the information stored in the memory. In that case, the verifier 420 may not authorize the corresponding network access node 620 and/or the terminal device 610 to share data including the telemetry data.

As denoted, the adversaries may aim an entity, such as the apparatus, tasked to execute the ML-based application relying on the consideration that the apparatus may include potentially malicious components, the components being hardware and/or software components. Furthermore, a network node that hosts the apparatus along with other potentially malicious components sharing the same infrastructure with the apparatus may also be targeted to modify and/or manipulate the telemetry data. Additionally, deployed rogue terminal devices (e.g. user devices, user equipments) and/or rogue network access nodes (e.g. rogue base stations) may prevent the devices, such as the terminal device 610, from performing seamless measurements of the telemetry data (e.g. RSRP measurements).

However, the threat surface may not be restricted to the mentioned threat models. An adversary may aim to disrupt the telemetry data by directly intervening in the measurement process of the telemetry data. A receiver (e.g. transceiver 204) of the terminal device 610 may typically perform measurements in both uplink and downlink transmissions using known sequences. A transmitter, such as the transmitter of the network access node 620 may transmit such sequences and accordingly, the receiver of the terminal device 610 may receive and decode the sequences to perform the measurements. In some aspects, the known sequences may include pilot sequences. In an example, the network operator 620 may transmit the pilot sequence, such as beamforming, and the terminal device 610 may receive the sequence.

Various aspects associated with detection of a jamming attack have been described herein, such that a device, as illustrated in FIG. 4 (i.e. the device 400), may implement such aspects. In particular, a network node that may able to process (e.g. a preprocessing as described above) telemetry data, such as an O-CU, an O-DU, or an RIC (e.g. a RT-RIC) may perform aspects described herein. The aspects have been described herein, such that the ML-based application may be implemented by a non-secure execution environment (i.e. not within a TEE), such as by the processor 401 and the memory 402, but this should not be taken as limiting. In some examples, the processor 411 and the memory 412 within the TEE may perform applicable aspects described herein. Furthermore, in various aspects, another network node may implement the ML-based application as described herein. In this particular example, the host processor 401 may encode the telemetry data for a transmission to another network node for a processing of the ML-based application.

The location of the pilot sequences in the time-frequency domain may be publicly known which may lead an adversary to use a wireless signal jammer to send low-power transmissions targeting the receiver or transceiver 204 of the terminal device 610. This may affect the measurements such as CSI, RSRP forming the telemetry data performed by the terminal device 610. As a result, the terminal device 610 may perform erroneous measurements due to the transmissions from the jammer, causing the telemetry data being tampered. Accordingly, the terminal device 610 may transmit erroneous telemetry data to the network access node 620 in the information flow pipeline. The network access node 610 may preprocess the measurements and may transmit intermediate results to the apparatus 405, causing a processor (e.g. the host processor 401) to execute an ML-based application to generate inaccurate output including network management parameters. Therefore, identification methods whether there is an over-the-air jammer attack based on the output of the ML-based application may be addressed.

In an example, the telemetry data may include channel measurements (e.g. RSRP measurements) to represent a radio communication channel. Illustratively, the channel measurements may be performed by the terminal device 610. The device 400 may receive the telemetry data. In accordance with various aspects described herein, the telemetry data may include channel measurements associated with a radio communication channel. An ML-based application may be configured to receive the telemetry data as an input, which the device 400 may include the ML-based application, or another network node may implement the ML-based application. In examples, that the ML-based application is implemented by the device, the host processor 401 (or the processor 411) may execute, via the host processor 401, the ML-based application to generate an output representing one or more network management parameters as described above.

Illustratively, the network management parameters may include handover management parameters for the network access node 620. The ML-based algorithm used may be a graph neural network. The host processor 401 may execute another model which includes a non-ML-based algorithm. Accordingly, the network node may initiate a handover based on the different outputs including network management parameters in which the different outputs may be originated from the ML-based and non-ML-based algorithms. The non-ML algorithm may include selection based on the maximum RSRP. The performance of both algorithms may be evaluated. The evaluation criteria may be the coverage rate as a performance metric derived from the outputs of the models using different handover algorithms (i.e. the ML-based and the non-ML-based algorithms) with respect to amount of perturbation. The outcome may point out that adversarial noise caused by the jammer may disrupt models using ML-based algorithms more than the models using non-ML-based algorithms. In that sense, a model using a non-ML-based application may be more robust than a model using an ML-based application. Thus, it may be evident that non-ML-based applications display better performance, mitigating the adversarial effect of a jammer attack.

FIG. 9 shows schematically an example of a chart displaying the performance of ML-based and non-ML-based algorithms in which the models leveraging both algorithms use perturbated/tampered telemetry data in the form of aggregated RSRP measurements where the perturbation originates from an effect of a jammer. As indicated, handovers initiated based on the outputs of both models may lead to different trajectories, noting the decrease of the performance of the ML-based algorithm, in particular, when perturbation amount increases. In case of a jammer attack and depending on the perturbation amount the performance of the ML-based application may be more inclined to degrade compared to the algorithms using exemplary maximum RSRP selection. In such case, ML-based algorithm may be more vulnerable to noisy input compared to an algorithm using exemplary maximum RSRP selection.

An adversary may aim to disrupt the channel measurements performed by the terminal device 610 by employing a jammer. Accordingly, the jammer may target the channel measurements forming the telemetry data, such as the RSRP measurements. In some aspects, the terminal device 610 may measure the radio communication channel based on signals received from the network access node 620. In some aspects the network access node 620 (e.g. an evolved node B, a next generation node B, an O-RU) may perform channel measurements (e.g. uplink channel measurements and/or based on received reference signals from the terminal device 610). In a scenario in which an adversary uses a jammer to disrupt the measurements, transmissions (e.g. low-power transmissions) from the jammer may overlap with the reference signal transmissions to introduce noise in the RSRP measurements. As exemplified, the ML-based applications may be more vulnerable to such noises introduced by the low-power transmissions from the jammer more than the non-ML-based applications.

The host processor 401 may be configured to detect a jamming attack targeting the radio communication channel, which the telemetry data may represent. In some examples, the host processor 401 may detect the jamming attack by analyzing the telemetry data. The telemetry data may illustratively include RSRP measurements, and the host processor 401 may analyze received RSRP measurements to determine whether a presence of a jamming attack is present within the radio communication channel.

In accordance with various aspects provided herein, the host processor 401 may store received RSRP measurements within the memory 402. In some examples, the host processor 401 may store received RSRP measurements, in a manner that stored RSRP measurements may include RSRP measurements of a designated period of time. Illustratively, stored RSRP measurements may include a plurality of RSRP measurement values, each measured at an instance of time within a period of time. In other words, the host processor 401 may obtain a plurality of RSRP measurements distributed in a period of time.

In some examples, the host processor 401 may detect a jamming attack by employing various statistical methods. Illustratively, the host processor 401 may determine whether there is a jamming attack or not by performing calculations according to a designated statistical model that may identify anomalies and/or outlier channel measurements. Furthermore, the host processor 401 may determine whether there is a jamming attack based on a metric (e.g. a threshold) applied to the performed calculations.

In some aspects, the host processor 401 may perform a linear averaging as one of the statistical methods. Considering that the jammers may have restricted time windows to initiate attacks by jamming transmissions that may target the radio communication channel, noting that the RSRP measurements may include measurements performed over a plurality of time frames. The host processor 401 may perform a statistical computation, such as fitting a Gaussian distribution over a series of RSRP measurements performed within the predefined time frames to determine RSRP measurements that are outliers. An outlier may be a measurement that falls outside the Gaussian distribution or outside a predefined error margin.

Illustratively, the host processor 401 may collect RSRP measurements over multiple time frames to create a dataset that may capture the variation in received signal power over time. The host processor 401 may apply statistical methods to the collected RSRP measurements, by performing statistical approaches like fitting a Gaussian distribution to the series of RSRP measurements within a designated time window. For this purpose, the host processor 401 may calculate parameters of a Gaussian curve (mean and standard deviation) that may represent the distribution of RSRP measurements within the dataset.

Furthermore, the host processor 401 may use one or more statistical thresholds, such as the number of standard deviations from the mean, to identify outlier RSRP measurements within the dataset. Outliers in this context may include measurements that significantly (e.g. over a designated threshold) deviate from the expected distribution which may be potential indicators of anomalous or jammed signals.

In accordance with various aspects provided herein, if the host processor 401 may identify such outliers, the host processor 401 may flag outlier RSRP measurements, illustratively for potential elimination from the dataset used for computing linear averaging of RSRP. Through flagging of such outliers, and possibly removing from the dataset and/or from the telemetry data itself may mitigate the impact of outliers or potentially jammed measurements on the overall RSRP determination. For example, the processor host processor may perform a further linear averaging of the RSRP measurements, in which flagged RSRP measurements are excluded or down-weighted to ensure that their influence on the average RSRP value is minimized.

In some aspects, an anomaly detection algorithm, such as autoencoders, one-class support vector machine (SVM), isolation forest may be employed to determine whether RSRP measurements are tampered by the jammer. To achieve this, an ML-based anomaly detector may receive a first data comprising RSRP measurements not tampered by a jammer attack. The ML-based anomaly detector may learn from the first data when executed by the host processor 401 in order to classify measurements as inliers and outliers. Thus, when the processor executes the ML-based anomaly detector whose input is a second dataset comprising tampered RSRP measurements, the ML-based anomaly detector may identify outliers, based on a threshold, representing the tampered RSRP measurements indicating the presence of a jammer attack.

In some aspects, the host processor 401 may use a generative ML model as the ML-based anomaly detector. The ML-based anomaly detector, when executed by the host processor 401, may learn from a primary RSRP measurements data including RSRP measurements that are not tampered by a jammer attack. In this case, the ML-based anomaly detector may learn from the conditional log likelihood (e.g. based on a maximum likelihood estimation approach) of untampered measurements. When a secondary RSRP measurements including tampered data is provided, the analysis of the ML-based anomaly detector may result in high scores in terms of log likelihood for the untampered measurements and low scores in terms of log likelihood for the tampered measurements indicating the presence of a jammer attack.

In accordance with various aspects described herein, the AI/ML unit 502 may implement the ML-based anomaly detector herein, in accordance with indicated differences associated with input and output data, and the aspects associated with training of the ML-based anomaly detector.

Exemplified methods to determine whether there is a jammer attack tampering with the channel measurements (e.g. RSRP measurements) may be implemented at a plurality of levels. In an example, the host processor 401 may perform the one or more methods described at CU, DU of the O-RAN systems. In some cases, the host processor 401 may perform the one or more methods described at near real-time RIC node. In some aspects, there may be a plurality of jammers aiming to disrupt channel measurements (e.g. RSRP measurements) performed by the terminal device 610. In that case, an ensemble of ML-based anomaly detectors may be employed to jointly detect the presence of plurality of jammer attacks based on the measurements. To achieve this, individual network actors may have ML-based anomaly detectors. In an example, the terminal device 610 may include a first set of anomaly detectors and the network node 410 may include a second set of anomaly detectors so that the ensemble of the anomaly detectors may detect tampered measurements (i.e. anomalies) in a collaborative manner. That is, even when one or more of the anomaly detectors fails to detect one or more anomalies, the majority of the detectors forming the ensemble may be able to detect those anomalies associated with tampered measurements to prove the presence of a jammer attack.

Although employing an anomaly detector may be associated with detecting the presence of a jammer attack, it may also be useful in the presence of rogue network nodes or rogue user devices. In some aspects, terminal device 610 or network node 410 may be compromised (e.g. a terminal device may be a rogue device). In an example, terminal device 610 may not support TPM and may be compromised. In such case, remote attestation may not possible for the network node 410 to verify the terminal device 610. Therefore, network node 410 may implement the ML-based anomaly detector to detect anomalous measurements representative of tampered measurement data. Similarly, score-based (e.g. log likelihood) generative models may also be used to identify anomalies in the measurements (e.g. RSRP measurements). In another example, network node 410 may be compromised. In such case, a trusted node (e.g. near real time RIC) may be able to receive the measurements to detect anomalies based on the techniques described.

In accordance with the various aspects provided herein, the host processor 401 may take defensive measures against a jammer attack. Despite that detecting the presence of a jammer attack may be critical, in some cases, it may need to be accompanied by mitigation techniques so that the measurements forming telemetry data (e.g. RSRP measurements) resembling the original (i.e. untampered) telemetry data may be obtained. Provided technique of performing linear averaging of RSRP measurements after elimination of the outliers may not be robust against a jammer attack capable of injecting noise in a targeted resource element within time-frequency resource components. Noise injection by the jammer may disrupt the overall measurement. Therefore, instead of linear averaging, more robust aggregation techniques of RSRP measurements across different resource elements may be provided. Such aggregation techniques may include utilizing statistical average, trimmed statistical average, median, mode, and the like. Those techniques may prevent a jammer from deviating the measurement data in one or more targeted resource element by a large margin. Therefore, overall RSRP measurement may resemble the original RSRP measurements (e.g. RSRP measurements performed without the presence of a jammer).

In some aspects, a scalable approach to mitigate the effect of a jammer attack may include training of ML-based application with measurement data containing adversarial noise. In an example, a processor, such as the host processor 401, may execute the ML-based application to generate output based on the input including RSRP measurements. The output may include decisions concerning network-wide handover and association of one or more user devices with the optimal network node. During the training of the ML-based application, one or more attacks may be conducted to artificially inject noise in the measurements so that the ML-based application may be trained with RSRP measurements including tampered measurement data. The attacks may be performed in a sandbox environment for the ML-based application, via the processor, to determine adversarial RSRP measurements (e.g. tampered measurements). In that case, ML-based application may become robust against adversarial tampering as it is trained with data including similar patterns that the tampered measurements have.

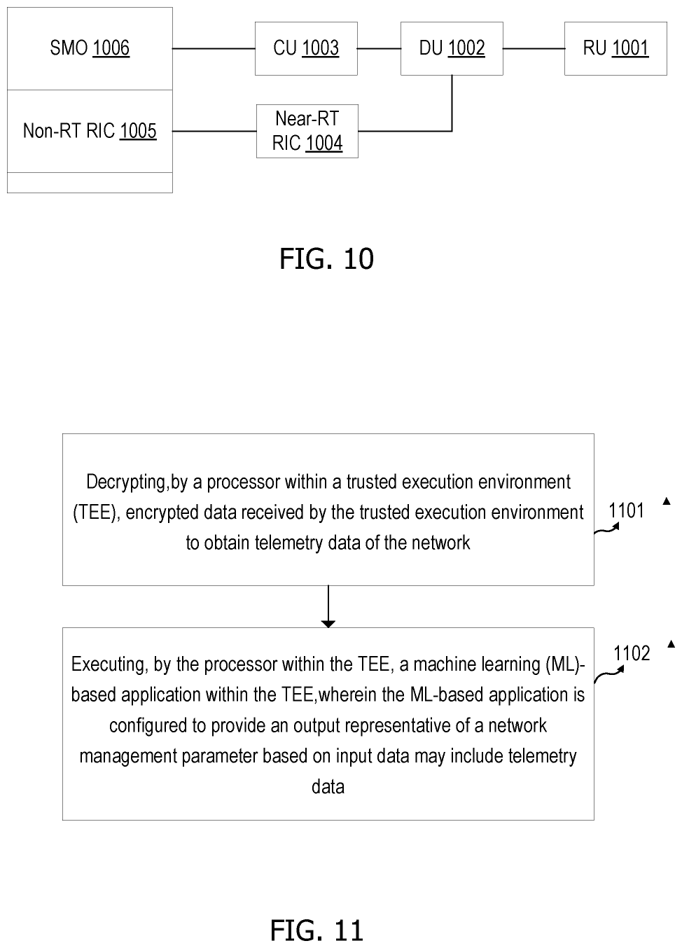

FIG. 10 shows an exemplary radio access network architecture in which the radio access network is disaggregated into multiple units. In LTE or 5G NR, network access nodes, such as a BS may implement the whole network stack including physical layer (PHY), media access control (MAC), radio link control (RLC), packet data convergence control (PDCP), and radio resource control (RRC) functions of the network stack. In a distributed approach of radio access networks, the processing of the network stack is disaggregated into at least two units (e.g. into RU, DU, and CU). Although the example illustrates a distributed structure that is based on open-RAN (O-RAN) architecture, the skilled person is able to populate the teaching provided herein in other types of distributed architectures, such as baseband unit (BBU) that may operate in the cloud and may be split to a Control Unit (CU) according to Rel.15 of 3GPP standards.

In various deployments in recently emerged RAN architectures, such as Open Radio Access Network (O-RAN) architectures, network access nodes may have functionalities that are split among multiple units with an intention to meet the demands of increased capacity requirements by providing a flexible and interoperable approach for RANs. The exemplary RAN 1000 provided herein includes a radio unit (RU) 1001, a DU 1002, a CU 1003, a near RT-RIC 1004, and a service management and orchestration framework (SMO) 1006 including a non-RT RIC 1005. The skilled person would recognize that the illustrated structure may represent a logical architecture, in which one or more of the entities of the mobile communication network may be implemented by the same physical entity, or a distributed physical entity (a plurality of devices operating collectively) may implement one of the entities of the mobile communication network provided herein.

There are many approaches to provide the split among the multiple units. In this illustrative example, the CU 1003 (e.g. O-CU) may be mainly responsible for non-real time operations hosting the radio resource control (RRC), the PDCP protocol, and the service data adaptation protocol (SDAP). The DU (e.g. O-DU) 1002 may be mainly responsible for real-time operations hosting, for example, RLC layer functions, MAC layer functions, and Higher-PHY functions. RUs 1001 (e.g. O-RU) may be mainly responsible for hosting the Lower-PHY functions to transmit and receive radio communication signals to/from terminal devices (e.g. UEs) and provide data streams to the DU over a fronthaul interface (e.g. open fronthaul). The SMO 1006 may provide functions to manage domains such as RAN management, Core management, Transport management, and the non-RT RIC 1005 may provide functions to support intelligent RAN optimization via policy-based guidance, AI/ML model management, etc. The near-RT RIC 1004 may provide functions for real time optimizations, including hosting one or more xApps that may collect real-time information (per UE or per Cell) and provide services, that may include AI/ML services as well.

The exemplary RAN 1000 is illustrated for the purpose of brevity. The skilled person would recognize the aspects provided herein and may also realize that the exemplary RAN 1000 may include further characterizations, such as the CU may also be—at least logically—distributed into two entities (e.g. CU-Control Plane, CU-User Plane), there may be various types of interfaces between different entities of the exemplary RAN 1000 (e.g. E2, F1, O1, X2, NG-u, etc.).

In accordance with the exemplary distributed RAN architecture, a UE may transmit radio communication signals to the RU 1001 and receive radio communication signals from the RU 1001. The processing associated with the communication is performed at the respective layers of the network stack by respective entities that are responsible to perform the corresponding function of the respective layers.

In accordance with various aspects of this disclosure and this exemplary RAN 1000, aspects associated with the management of radio resources may include MAC layer functions within the DU 1002. In accordance with various aspects provided herein, the DU 1002 may include the device 400. The device 400 of the DU 1002 may implement aspects associated with i) execution of an ML-based application within a TEE; and/or ii) authenticating and/or verifying identity and trust of the RU 1001, CU 1003, RICs 1004, 1005; and/or iii) detection of jamming attacks. The device 400 may receive the telemetry data from the RU 1001. In some examples, the device 400 may encode the telemetry data for transmission to the CU 1003 or RICs 1004, 1005.

In accordance with various aspects of this disclosure and this exemplary RAN 1000, the CU 1003 may include the device 400. The device 400 of the CU 1003 may implement aspects associated with i) execution of an ML-based application within a TEE; and/or ii) authenticating and/or verifying identity and trust of the RU 1001, DU 1002, and/or RICs 1004, 1405; and/or iii) detection of jamming attacks. The device 400 may receive the telemetry data from the DU 1002. In some examples, the device 400 may encode the telemetry data for transmission to the RICs 1004, 1005.

In accordance with various aspects of this disclosure and this exemplary RAN 1000, the near-RT RIC 1004 may include the device 400. The device 400 of the near-RT-RIC may implement aspects associated with i) execution of an ML-based application within a TEE; and/or ii) authenticating and/or verifying identity and trust of the RU 1001, DU 1002, CU 1003, non-RT RIC 1005; and/or iii) detection of jamming attacks. The device 400 may receive the telemetry data from the DU 1002 and/or the CU 1003. In some examples, the device 400 may encode the telemetry data for transmission to the non-RT RIC 1005.

In accordance with various aspects of this disclosure and this exemplary RAN 1000, the non-RT RIC 1005 may include the device 400. The device 400 of the non-RT-RIC may implement aspects associated with i) execution of an ML-based application within a TEE; and/or ii) authenticating and/or verifying identity and trust of the RU 1001, DU 1002, CU 1003, near-RT RIC 1004; and/or iii) detection of jamming attacks. The device 400 may receive the telemetry data from the DU 1002 and/or the CU 1003.

FIG. 11 shows an example of a method. The method may include: decrypting 1101, by a processor within a trusted execution environment (TEE), encrypted data received by the trusted execution environment to obtain telemetry data of the network; executing 1102, by the processor within the TEE, a machine learning (ML)-based application within the TEE, wherein the ML-based application is configured to provide an output representative of a network management parameter based on input data may include telemetry data.

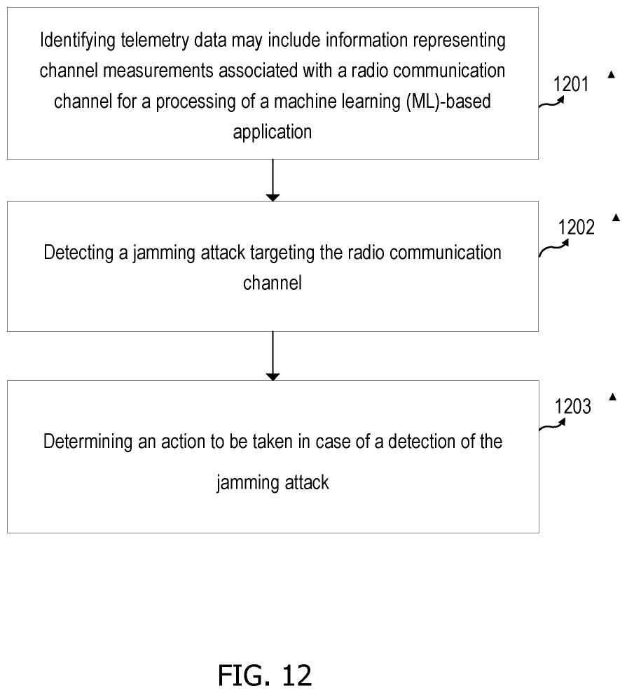

FIG. 12 shows an example of a method. The method may include: identifying 1201 telemetry data may include information representing channel measurements associated with a radio communication channel for a processing of a machine learning (ML)-based application; detecting 1202 a jamming attack targeting the radio communication channel; determining 1203 an action to be taken in case of a detection of the jamming attack.

In some examples, a non-transitory computer-readable medium may include instructions which, when executed by a processor, cause the processor to perform any aspects described herein, in particular methods described in accordance with FIGS. 11 and 12.

Further examples of this disclosure are described here:

In example 1, the subject matter includes an apparatus of a network node associated with a network, the apparatus may include: a trusted execution environment (TEE) including a processor configured to: decrypt encrypted data received by the trusted execution environment to obtain telemetry data of the network; execute a machine learning (ML)-based application within the TEE, wherein the ML-based application is configured to provide an output representative of a network management parameter based on input data may include telemetry data.

In example 2, the subject matter of example 1, wherein the TEE includes a secure enclave isolated from one or more applications executed at the network node.

In example 3, the subject matter of example 3, wherein the ML-based application is executed within the secure enclave.

In example 4, the subject matter of example 2 or example 3, wherein the processor is further configured with the decryption key to decrypt the encrypted data; wherein the decryption key is stored in the secure enclave.

In example 5, the subject matter of any one of examples 2 to 4, wherein the processor is further configured to generate the input data may include input feature vectors based on the telemetry data of the network by processing the telemetry data in the secure enclave.

In example 6, the subject matter of any one of examples 2 to 5, wherein the processor is further configured to generate an encryption key and store the decryption key in the secure enclave.

In example 7, the subject matter of any one of examples 1 to 6, wherein the processor is further configured to encode a decryption key based on the encryption key for a transmission to another network node associated with the network.

In example 8, the subject matter of example 7, wherein the encryption key and the decryption key based on the encryption key are obtained in accordance with a private-public key generation method.

In example 9, the subject matter of any one of examples 1 to 8, wherein the processor is further configured to encrypt data at the output of the ML-based application to obtain encrypted output data; wherein the processor is further configured to encode the encrypted output data for a transmission to the another network node.

In example 10, the subject matter of any one of examples 1 to 9, wherein the ML-based application is configured to output a network management parameter based on the telemetry data.

In example 11, the subject matter of example 10, wherein the network management parameter includes a parameter of at least one of: a network traffic steering, a radio resource management, a radio resource scheduling, an antenna configuration; a multiple input multiple output (MIMO) transmission mode, a handover management, a massive MIMO optimization.

In example 12, the subject matter of any one of examples 1 to 11, wherein the telemetry data includes at least one of a reference signal received power (RSRP) measurement, an RSRP report, a channel state information (CSI), a measurement of a radio communication channel.

In example 13, the subject matter of any one of examples 1 to 12, wherein the encrypted data has been received from a further network node associated with the network.

In example 14, the subject matter of any one of examples 1 to 13, wherein the processor is further configured to authenticate a source node of the telemetry data based on a hardware-based authentication method.

In example 15, the subject matter of example 14, wherein the processor is further configured to generate a cryptographic key within a hardware-based security component; wherein the processor is further configured to sign information encoded for a transmission to the source node using the cryptographic key.

In example 16, the subject matter of example 15, wherein the processor is configured to instruct the hardware-based security component to generate a quote for an attestation in response to a received attestation request.

In example 17, the subject matter of any one of examples 14 to 16, wherein the source node is an authenticated node based on an attestation procedure.

In example 18, the subject matter of example 17, wherein the processor is further configured to decode information received from a verifying entity of the network, wherein the decoded information is representative of that the source node has been verified according to the attestation procedure.

In example 19, a network node of a radio communication network, the network node may include: the apparatus of any one of examples 1 to 18; a transceiver configured to provide communication between the network node and other network nodes of the radio communication network.

In example 20, the network node of example 19, wherein the radio communication network is an open radio access network (O-RAN), wherein the network node is at least one of an O-RAN distributed unit (O-DU), an O-RAN centralized unit (O-CU), or a RAN intelligent controller (RIC).

In example 21, the subject matter includes an apparatus of a network node associated with a network, the apparatus may include: a processor configured to: encode telemetry data may include information representing channel measurements associated with a radio communication channel for a processing of a machine learning (ML)-based application; detect a jamming attack targeting the radio communication channel; determine an action to be taken in case of a detection of the jamming attack.

In example 22, the subject matter of example 21, wherein the processor is configured to determine a presence of the jamming attack based on a distribution of received signal measurements.

In example 23, the subject matter of example 21 or 22, wherein the processor is configured to detect the jamming attack based on an analysis of reference signal receive power (RSRP) measurements.

In example 24, the subject matter of example 23, wherein the processor is configured to perform a plurality of RSRP measurements distributed in a period of time; wherein the processor is configured to identify one or more outlier RSRP measurements from the plurality of RSRP measurements.

In example 25, the subject matter of example 24, wherein the processor is further configured to determine the one or more outlier RSRP measurements based on a statistical model and a metric associated with the statistical model.

In example 26, the subject matter of example 24, wherein the processor is further configured to use an ML-based anomaly detector to identify the one or more outlier RSRP measurements.

In example 27, the subject matter of example 26, wherein the ML-based anomaly detector includes a trained machine learning model configured to classify the plurality of RSRP measurements into a first set of RSRP measurements may include the one or more outlier RSRP measurements and a second set of RSRP measurements.

In example 28, the subject matter of example 27, wherein the ML-based anomaly detector is trained using training data may include exclusively RSRP measurements without a presence of a jamming attack.

In example 29, the subject matter of example 28, wherein the ML-based anomaly detector is configured to calculate a reconstruction loss based on input data.

In example 30, the subject matter of example 29, wherein the ML-based anomaly detector is configured to classify the plurality of RSRP measurements into the first set of RSRP measurements and the second set of RSRP measurements based on a corresponding reconstruction loss for each RSRP measurement of the plurality of RSRP measurements and a threshold.

In example 31, the subject matter of any one of examples 28 to 30, wherein the ML-based anomaly detector includes a generative machine learning model trained to learn conditional log-likelihood of RSRP measurements without a presence of a jamming attack.

In example 32, the subject matter of any one of examples 24 to 31, wherein the processor is further configured to exclude the one or more outlier RSRP measurements from the channel measurements; wherein the channel measurements include remaining RSRP measurements of the plurality of RSRP measurements, which the remaining RSRP measurements are not the one or more outlier RSRP measurements.

In example 33, the subject matter of any one of examples 21 to 32, wherein the processor is further configured to determine a configuration to mitigate an effect of the jamming attack.

In example 34, the subject matter of any one of examples 21 to 33, wherein the processor is configured to determine an RSRP measurement based on a linear averaging in a first configuration; wherein the processor is configured to determine, in a second configuration responsive to a detection of the jamming attack, determine the RSRP measurement based on robust statistical aggregation techniques such as median, mode, trimmed mean among others.

In example 35, the subject matter of any one of examples 21 to 34, further may include a memory configured to store the channel measurements.

In example 36, the subject matter of any one of examples 21 to 35, further may include a transceiver configured to receive radio communication signals; wherein the transceiver includes measurement circuitry configured to perform the channel measurements.

In example 37, the subject matter of any one of examples 21 to 36, wherein the radio communication channel is of an open radio access network (O-RAN); wherein the processor is configured to encode the telemetry data for a transmission to another entity of the O-RAN configured to implement the machine learning (ML)-based application.

In example 38, the subject matter includes a method that may include: decrypting, by a processor within a trusted execution environment (TEE), encrypted data received by the trusted execution environment to obtain telemetry data of the network; executing, by the processor within the TEE, a machine learning (ML)-based application within the TEE, wherein the ML-based application is configured to provide an output representative of a network management parameter based on input data may include telemetry data.

In example 39, the subject matter of example 38, wherein the TEE includes a secure enclave isolated from one or more applications executed at the network node.

In example 40, the subject matter of example 39, wherein the ML-based application is executed within the secure enclave.

In example 41, the subject matter of example 39 or example 40, further may include configuring with the decryption key to decrypt the encrypted data; wherein the decryption key is stored in the secure enclave.

In example 42, the subject matter of any one of examples 38 to 41, further may include generating the input data may include input feature vectors based on the telemetry data of the network by processing the telemetry data in the secure enclave.

In example 43, the subject matter of any one of examples 38 to 42, further may include generating an encryption key and store the decryption key in the secure enclave.

In example 44, the subject matter of any one of examples 38 to 43, further may include encoding a decryption key based on the encryption key for a transmission to another network node associated with the network.

In example 45, the subject matter of example 44, wherein the encryption key and the decryption key based on the encryption key are obtained in accordance with a private-public key generation method.

In example 46, the subject matter of any one of examples 38 to 45, further may include: encrypting data at the output of the ML-based application to obtain encrypted output data; encoding the encrypted output data for a transmission to the another network node.

In example 47, the subject matter of any one of examples 38 to 46, wherein the ML-based application is configured to output a network management parameter based on the telemetry data.

In example 48, the subject matter of example 47, wherein the network management parameter includes a parameter of at least one of: a network traffic steering, a radio resource management, a radio resource scheduling, an antenna configuration; a multiple input multiple output (MIMO) transmission mode, a handover management, a massive MIMO optimization.

In example 49, the subject matter of any one of examples 38 to 48, wherein the telemetry data includes at least one of a reference signal received power (RSRP) measurement, an RSRP report, a channel state information (CSI), a measurement of a radio communication channel.

In example 50, the subject matter of any one of examples 38 to 49, wherein the encrypted data has been received from a further network node associated with the network.

In example 51, the subject matter of any one of examples 38 to 50, further may include authenticating a source node of the telemetry data based on a hardware-based authentication method.

In example 52, the subject matter of example 51, further may include generating a cryptographic key within a hardware-based security component; signing information encoded for a transmission to the source node using the cryptographic key.

In example 53, the subject matter of example 52, further may include instructing the hardware-based security component to generate a quote for an attestation in response to a received attestation request.

In example 54, the subject matter of any one of examples 51 to 53, wherein the source node is an authenticated node based on an attestation procedure.

In example 55, the subject matter of example 54, further may include decoding information received from a verifying entity of the network, wherein the decoded information is representative of that the source node has been verified according to the attestation procedure.

In example 56, the subject matter includes a method that may include: identifying telemetry data may include information representing channel measurements associated with a radio communication channel for a processing of a machine learning (ML)-based application; detecting a jamming attack targeting the radio communication channel; determining an action to be taken in case of a detection of the jamming attack.

In example 57, the subject matter of example 56, wherein the processor is configured to determine a presence of the jamming attack based on a distribution of received signal measurements.

In example 58, the subject matter of example 56 or 57, further may include detecting the jamming attack based on an analysis of reference signal receive power (RSRP) measurements.

In example 59, the subject matter of example 58, further may include performing a plurality of RSRP measurements distributed in a period of time; identifying one or more outlier RSRP measurements from the plurality of RSRP measurements.

In example 60, the subject matter of example 59, further may include determining the one or more outlier RSRP measurements based on a statistical model and a metric associated with the statistical model.

In example 61, the subject matter of example 59, further may include using an ML-based anomaly detector to identify the one or more outlier RSRP measurements.

In example 62, the subject matter of example 61, wherein the ML-based anomaly detector includes a trained machine learning model configured to classify the plurality of RSRP measurements into a first set of RSRP measurements may include the one or more outlier RSRP measurements and a second set of RSRP measurements.

In example 63, the subject matter of example 62, wherein the ML-based anomaly detector is trained using training data may include exclusively RSRP measurements without a presence of a jamming attack.

In example 64, the subject matter of example 63, wherein the ML-based anomaly detector is configured to calculate a reconstruction loss based on input data.

In example 65, the subject matter of example 64, wherein the ML-based anomaly detector is configured to classify the plurality of RSRP measurements into the first set of RSRP measurements and the second set of RSRP measurements based on a corresponding reconstruction loss for each RSRP measurement of the plurality of RSRP measurements and a threshold.

In example 66, the subject matter of any one of examples 63 to 65, wherein the ML-based anomaly detector includes a generative machine learning model trained to learn conditional log-likelihood of RSRP measurements without a presence of a jamming attack.

In example 67, the subject matter of any one of examples 59 to 66, further may include excluding the one or more outlier RSRP measurements from the channel measurements; wherein the channel measurements include remaining RSRP measurements of the plurality of RSRP measurements, which the remaining RSRP measurements are not the one or more outlier RSRP measurements.

In example 68, the subject matter of any one of examples 56 to 67, further may include determining a configuration to mitigate an effect of the jamming attack.

In example 69, the subject matter of any one of examples 56 to 68, further may include determining an RSRP measurement based on a linear averaging in a first configuration; determining, in a second configuration responsive to a detection of the jamming attack, determine the RSRP measurement based on robust statistical aggregation techniques such as median, mode, trimmed mean among others.

In example 70, a non-transitory computer-readable medium may include one or more instructions which, if executed by a processor, cause the processor to perform the method of any one of examples 38 to 69.

The word “exemplary” is used herein to mean “serving as an example, instance, or illustration”. Any embodiment or design described herein as “exemplary” is not necessarily to be construed as preferred or advantageous over other embodiments or designs.

The words “plurality” and “multiple” in the description or the claims expressly refer to a quantity greater than one. The terms “group (of)”, “set [of]”, “collection (of)”, “series (of)”, “sequence (of)”, “grouping (of)”, etc., and the like in the description or in the claims refer to a quantity equal to or greater than one, i.e. one or more. Any term expressed in plural form that does not expressly state “plurality” or “multiple” likewise refers to a quantity equal to or greater than one.

Any vector and/or matrix notation utilized herein is exemplary in nature and is employed solely for purposes of explanation. Accordingly, the apparatuses and methods of this disclosure accompanied by vector and/or matrix notation are not limited to being implemented solely using vectors and/or matrices, and that the associated processes and computations may be equivalently performed with respect to sets, sequences, groups, etc., of data, observations, information, signals, samples, symbols, elements, etc.

As used herein, “memory” is understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, registers, shift registers, processor registers, data buffers, etc., are also embraced herein by the term memory. A single component referred to as “memory” or “a memory” may be composed of more than one different type of memory, and thus may refer to a collective component including one or more types of memory. Any single memory component may be separated into multiple collectively equivalent memory components, and vice versa. Furthermore, while memory may be depicted as separate from one or more other components (such as in the drawings), memory may also be integrated with other components, such as on a common integrated chip or a controller with an embedded memory.

The term “software” refers to any type of executable instruction, including firmware.

In the context of this disclosure, the term “process” may be used, for example, to indicate a method. Illustratively, any process described herein may be implemented as a method (e.g., a channel estimation process may be understood as a channel estimation method). Any process described herein may be implemented as a non-transitory computer readable medium including instructions configured, when executed, to cause one or more processors to carry out the process (e.g., to carry out the method).

Throughout the drawings, it should be noted that like reference numbers are used to depict the same or similar elements, features, and structures, unless otherwise noted. It should be noted that certain components may be omitted for the sake of simplicity. It should be noted that nodes (dots) are provided to identify the circuit line intersections in the drawings including electronic circuit diagrams.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

As used herein, a signal or information that is “indicative of”, “representative”, “representing”, or “indicating” a value or other information may be a digital or analog signal that encodes or otherwise, communicates the value or other information in a manner that can be decoded by and/or cause a responsive action in a component receiving the signal. The signal may be stored or buffered in computer-readable storage medium prior to its receipt by the receiving component and the receiving component may retrieve the signal from the storage medium. Further, a “value” that is “indicative of” or “representative” some quantity, state, or parameter may be physically embodied as a digital signal, an analog signal, or stored bits that encode or otherwise communicate the value.

As used herein, a signal may be transmitted or conducted through a signal chain in which the signal is processed to change characteristics such as phase, amplitude, frequency, and so on. The signal may be referred to as the same signal even as such characteristics are adapted. In general, so long as a signal continues to encode the same information, the signal may be considered as the same signal. For example, a transmit signal may be considered as referring to the transmit signal in baseband, intermediate, and radio frequencies.

The terms “processor” or “controller” as, for example, used herein may be understood as any kind of technological entity that allows handling of data. The data may be handled according to one or more specific functions executed by the processor. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The terms “one or more processors” is intended to refer to a processor or a controller. The one or more processors may include one processor or a plurality of processors. The terms are simply used as an alternative to the “processor” or “controller”.

The term “user device” is intended to refer to a device of a user (e.g. occupant) that may be configured to provide information related to the user. The user device may exemplarily include a mobile phone, a smart phone, a wearable device (e.g. smart watch, smart wristband), a computer, etc.

As utilized herein, terms “module”, “component,” “system,” “circuit,” “element,” “slice,” “circuit,” and the like are intended to refer to a set of one or more electronic components, a computer-related entity, hardware, software (e.g., in execution), and/or firmware. For example, circuit or a similar term can be a processor, a process running on a processor, a controller, an object, an executable program, a storage device, and/or a computer with a processing device. By way of illustration, an application running on a server and the server can also be circuit. One or more circuits can reside within the same circuit, and circuit can be localized on one computer and/or distributed between two or more computers. A set of elements or a set of other circuits can be described herein, in which the term “set” can be interpreted as “one or more”.

The terminology in accordance with open-RAN (O-RAN) specifications is to be considered for Radio Units (RUs), Distributed Units (DUs) and Centralized Units (CUs). Inherently, a base station is considered to be disaggregated into such units in accordance with layers of a corresponding protocol stack into these logical nodes, which all of them can be implemented by the same device or multiple devices in which each device may be deployed with one of these units.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art. The term “data item” may include data or a portion of data.

It will be understood that when an element is referred to as being “connected” or “coupled” to another element, it can be physically connected or coupled to the other element such that current and/or electromagnetic radiation (e.g., a signal) can flow along a conductive path formed by the elements. Inherently, such element is connectable or couplable to the another element. Intervening conductive, inductive, or capacitive elements may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being “provided” to an element, the voltage, current, or signal may be conducted to the element by way of a physical connection or by way of capacitive, electro-magnetic, or inductive coupling that does not involve a physical connection.

Unless explicitly specified, the term “instance of time” refers to a time of a particular event or situation according to the context. The instance of time may refer to an instantaneous point in time, or to a period of time which the particular event or situation relates to.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

Unless explicitly specified, the term “performance metric” refers to a quantitative measure used to evaluate the effectiveness, efficiency, or success of a system, process, or operation in achieving its designated objectives. For an AI/ML generally, a performance metric may include a quantitative measure to evaluate the effectiveness, accuracy, and/or quality of a trained model's predictions or classifications compared to the ground truth or actual values. It is to be noted that a performance metric of an AI/ML used for RRM operation, may also include a performance metric of RAN as the performance metric of the RAN is directly affected with the performance of the AI/ML. RAN performance metrics may include coverage (e.g. signal strength, cell capacity), capacity (e.g. traffic volume, cell capacity), QoS (data rate (throughput), latency, packet loss rate, call drop rate), resource utilization (spectrum efficiency, energy efficiency), mobility performance (handover success rate, mobile robustness), etc. The RAN performance metrics may be indicated via KPMs. Depending on the measure of the “performance”, performance metrics may include also measure to evaluate costs and/or expenses (i.e. cost expenses) in this disclosure, such as computation overhead (i.e. cost of computing), power consumption (i.e. cost of power), communication (i.e. cost of communication), unless these terms are distinguished explicitly.

While the above descriptions and connected figures may depict electronic device components as separate elements, skilled persons will appreciate the various possibilities to combine or integrate discrete elements into a single element. Such may include combining two or more circuits to form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method. All acronyms defined in the above description additionally hold in all claims included herein.

What is claimed is:

1. An apparatus of a network node associated with a network, the apparatus comprising:
a trusted execution environment (TEE) comprising
a processor configured to:
decrypt encrypted data received by the TEE to determine telemetry data of the network; and
execute a machine learning (ML)-based application within the TEE to provide an output representative of a network management parameter based on the determined telemetry data.

2. The apparatus of claim 1,
wherein the TEE comprises a secure enclave isolated from one or more applications executed at the network node.

3. The apparatus of claim 2,
wherein the ML-based application is executed within the secure enclave.

4. The apparatus of claim 2,
wherein the processor is further configured with the decryption key to decrypt the encrypted data;
wherein the decryption key is stored in the secure enclave.

5. The apparatus of claim 2,
wherein the processor is further configured to generate the input data comprising input feature vectors based on the telemetry data of the network by processing the telemetry data in the secure enclave.

6. The apparatus of claim 2,
wherein the processor is further configured to generate an encryption key and store the decryption key in the secure enclave.

7. The apparatus of claim 1,
wherein the processor is further configured to encrypt data at the output of the ML-based application to obtain encrypted output data; and
wherein the processor is further configured to encode the encrypted output data for a transmission to the another network node.

8. The apparatus of claim 1,
wherein the network management parameter comprises a parameter of at least one of: a network traffic steering, a radio resource management, a radio resource scheduling, an antenna configuration; a multiple input multiple output (MIMO) transmission mode, a handover management, a massive MIMO optimization.

9. The apparatus of claim 1,
wherein the processor is further configured to authenticate a source node of the telemetry data based on a hardware-based authentication method.

10. The apparatus of claim 9,
wherein the processor is further configured to generate a cryptographic key within a hardware-based security component;
wherein the processor is further configured to sign information encoded for a transmission to the source node using the cryptographic key.

11. The apparatus of claim 10,
wherein the processor is configured to instruct the hardware-based security component to generate a quote for an attestation in response to a received attestation request.

12. A network node of a radio communication network, the network node comprising:
an apparatus comprising:
a trusted execution environment (TEE) comprising
a processor configured to:
decrypt encrypted data received by the TEE to determine telemetry data of the radio communication network; and
execute a machine learning (ML)-based application within the TEE to provide an output representative of a network management parameter based on the determined telemetry data; and
a transceiver configured to provide communication between the network node and other network nodes of the radio communication network.

13. The network node of claim 12,
wherein the radio communication network is an open radio access network (O-RAN);
wherein the network node is at least one of an O-RAN distributed unit (O-DU), an O-RAN centralized unit (O-CU), or a RAN intelligent controller (RIC).

14. An apparatus of a network node associated with a network, the apparatus comprising:
a processor configured to:
encode telemetry data comprising information representing channel measurements associated with a radio communication channel for a processing of a machine learning (ML)-based application;
detect a jamming attack targeting the radio communication channel;
determine an action to be taken in case of a detection of the jamming attack.

15. The apparatus of claim 14,
wherein the processor is configured to determine a presence of the jamming attack based on a distribution of received signal measurements.

16. The apparatus of claim 14,
wherein the processor is configured to detect the jamming attack based on an analysis of reference signal receive power (RSRP) measurements.

17. The apparatus of claim 16,
wherein the processor is configured to perform a plurality of RSRP measurements distributed in a period of time;
wherein the processor is configured to identify one or more outlier RSRP measurements from the plurality of RSRP measurements; and
wherein the processor is further configured to determine the one or more outlier RSRP measurements based on a statistical model and a metric associated with the statistical model.

18. The apparatus of claim 17,
wherein the processor is further configured to use an ML-based anomaly detector to identify the one or more outlier RSRP measurements.

19. The apparatus of claim 14,
wherein the processor is further configured to exclude the one or more outlier RSRP measurements from the channel measurements; and
wherein the channel measurements comprise remaining RSRP measurements of the plurality of RSRP measurements, which the remaining RSRP measurements are not the one or more outlier RSRP measurements.

20. The apparatus of claim 14,
wherein the processor is further configured to determine a configuration to mitigate an effect of the jamming attack.
